(19) United States
(12) Patent Application Publication
(10) Pub. No.: US 2023/0076135 A1
(43) Pub. Date: Mar. 9, 2023

(54) MULTI-SPEED IN-WHEEL DRIVE FOR LAND TRANSPORT VEHICLES

(71) Applicant: FATHOM5, Austin, TX (US)

(72) Inventor: Delbert Tesar, Austin, TX (US)

(21) Appl. No.: 17/891,124

(22) Filed: Aug. 18, 2022

Related U.S. Application Data
(60) Provisional application No. 63/232,423, filed on Aug. 12, 2021.

(51) Int. Cl. F16H 3/089; F16H 3/04

(52) U.S. Cl. CPC F16H 3/089; F16H 3/04

(57) ABSTRACT

An actuator is provided which includes a star compound gear train; a housing which houses said star compound gear train, said housing terminating in a back wall, wherein said back wall has an indentation defined therein; and a bearing assembly which includes first and second races and a plurality of bearings, wherein said first race is disposed in said indentation.

### CROSS-REFERENCE TO RELATED APPLICATION

This application claims the benefit of priority from U.S. Provisional Application No. 63/232,423, filed Aug. 12, 2021, having the same inventor and the same title, and which is incorporated herein by reference in its entirety.

### FIELD OF THE DISCLOSURE

The present disclosure relates generally to in-wheel drives, and more particularly to multi-speed drive wheels and multi-speed transmissions.

### BACKGROUND OF THE DISCLOSURE

There is a continuing urgency to develop cost-effective and energy-efficient electric drivelines for cars and other light vehicles. Most on the market are at the high end (Tesla, Jaguar, Mercedes) with some attempt towards mid-price units (Volt, Colt, Prius). The key technologies involve the use of a synchronous AC and brushless DC motor to drive a gearbox that creates sufficient wheel torque to effectively accelerate the vehicle.

Some examples of in-wheel drives (vehicles with a motor in the wheel) are known to the art, although many existing in-wheel drives tend to be too heavy or too expensive. Weak in-wheel examples of a motor and one-speed gearbox have resulted in low torque-too-weight ratios.

### BRIEF DESCRIPTION OF THE DRAWINGS

FIG. 1 is an illustration of a multi-speed drive wheel (MDW) in accordance with the teachings herein.

FIG. 2 is a cross-section taken along LINE A-A of FIG. 3.

FIG. 3 is an axial view of a principal bearing/output gear for a 20 H.P. MDW (with the shortest force path for maximum stiffness/minimum weight) in accordance with the teachings herein.

FIG. 4 is a perspective view of the principal bearing/output gear of FIG. 3.

FIG. 5 is an illustration of the strong back wall interface to the gear bearing and attachment frames for rapid/precision assembly.

FIG. 6 is a cross-sectional illustration of an embodiment of a two-speed multi-speed drive wheel in accordance with the teachings herein.

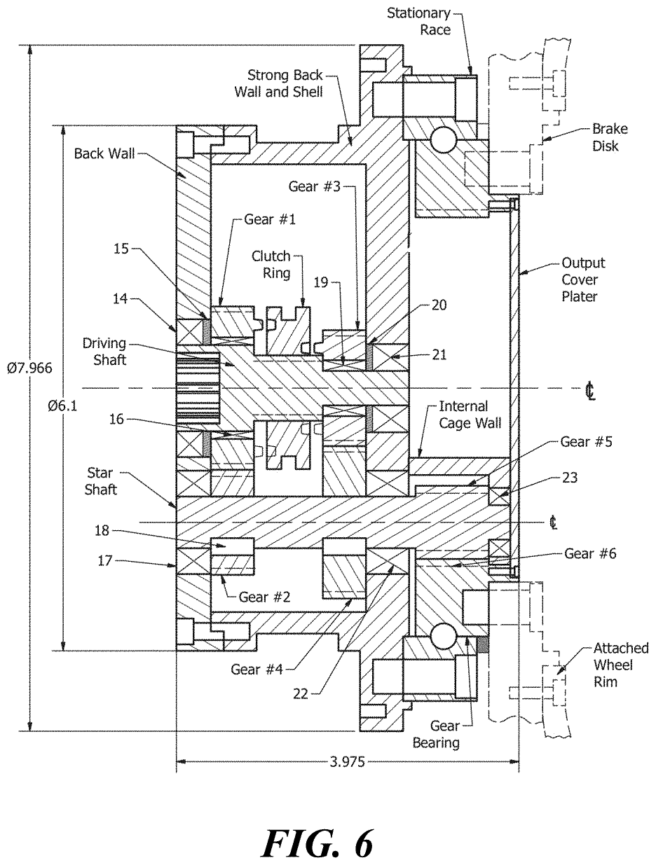

FIG. 7 is a perspective view of an embodiment of a strong back wall and shell of a multi-speed drive wheel in accordance with the teachings herein.

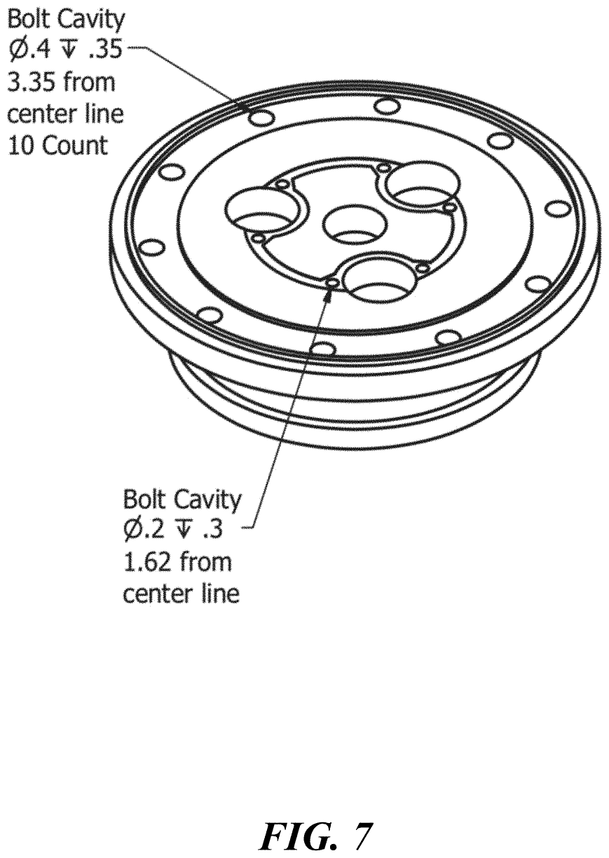

FIG. 8 is a perspective view of an embodiment of an internal cage wall of a multi-speed drive wheel in accordance with the teachings herein.

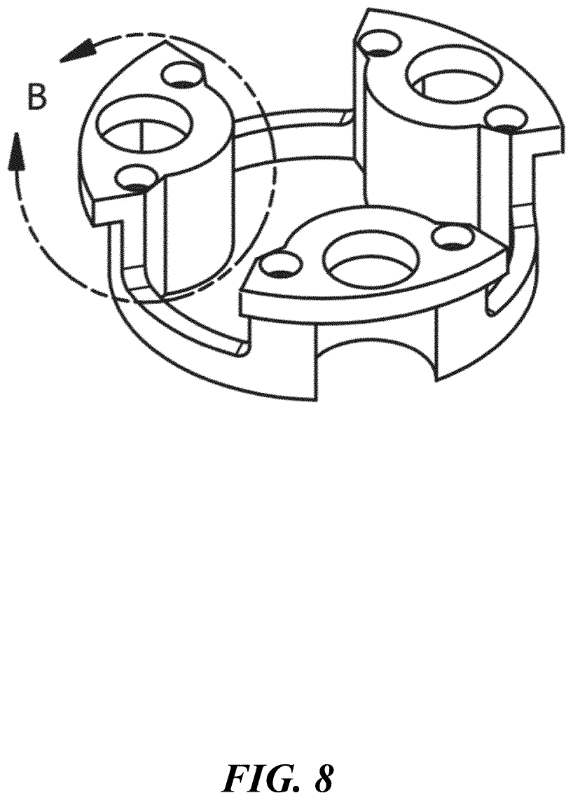

FIG. 9 is an illustration of an embodiment of a pancake low complexity reducer (using the gear bearing output structure) in accordance with the teachings herein.

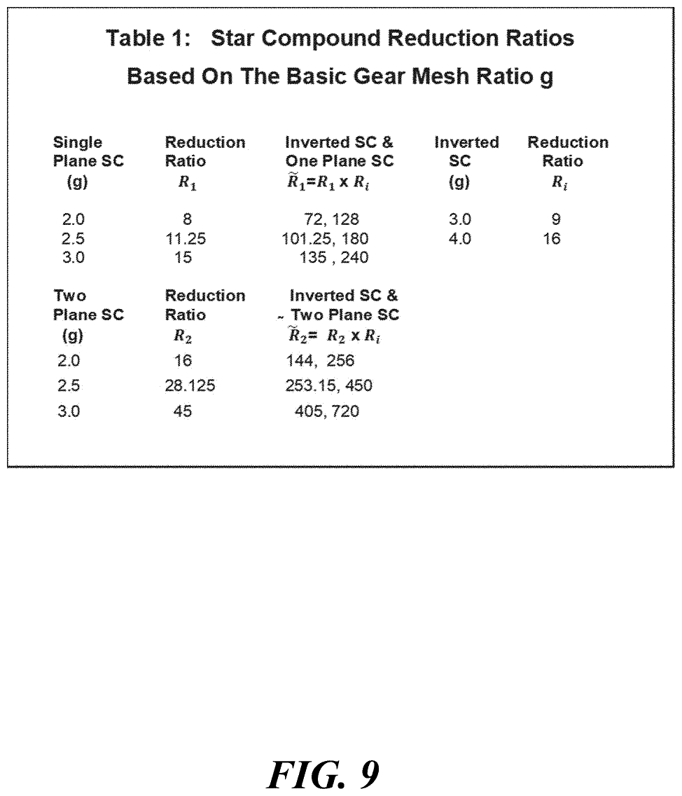

FIG. 10 is a chart of some basic star compound reduction ratios based on the basic gear mesh ratio g.

FIG. 11 is an illustration of an embodiment of a strong back wall interface to the gear bearing and attachment frames in accordance with the teachings herein.

FIG. 12 is an illustration of an embodiment of the internal gear placement for a two plane star compound gear reducer in accordance with the teachings herein.

FIG. 13 is an illustration of an embodiment of an inverted star compound gear reducer in accordance with the teachings herein.

FIG. 14 is an illustration of an embodiment of a coffee can low complexity gear reducer (using a gear bearing) in accordance with the teachings herein.

FIG. 15 is an exploded view of a two-speed electric multi-speed drive wheel.

FIG. 16 is an illustration of a preliminary design for a multi-speed drive wheel with emphasis on precision assembly surfaces.

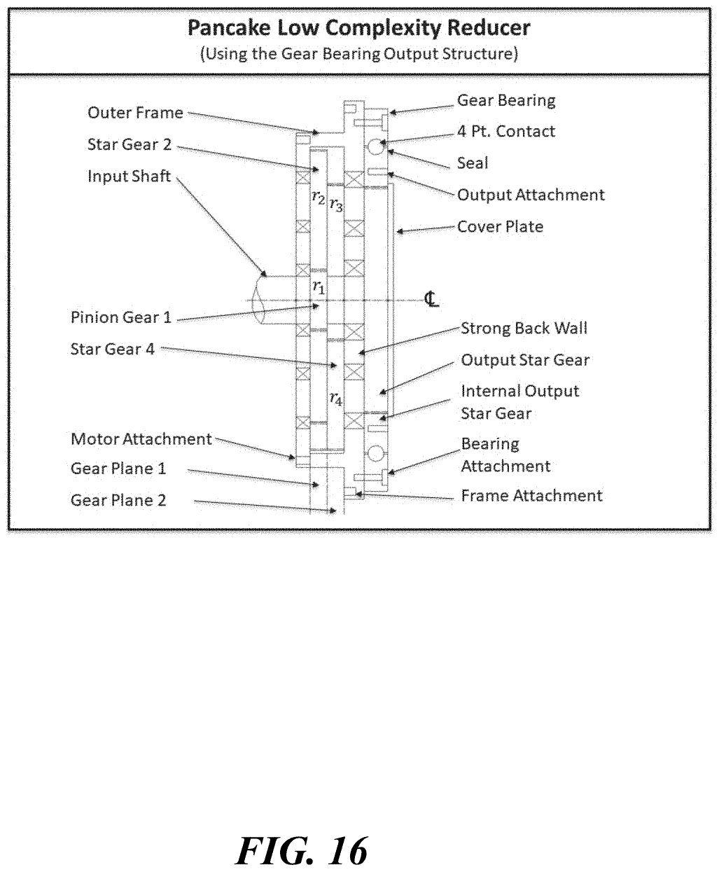

FIG. 17 is an illustration of two-speed star compound gear reducer modules in accordance with the teachings herein.

FIG. 18 is an illustration of a 4-speed transmission in accordance with the teachings herein which is made by combining modules of the type depicted in FIG. 17.

FIG. 19 is an exploded view of an example of a 4-speed electric multi-speed drive wheel in accordance with the teachings herein.

### SUMMARY OF THE DISCLOSURE

In one aspect, an actuator is provided which comprises (a) a rotor; (b) a stator; (c) a housing having first and second opposing plates adjoined by an annular side wall; (d) a bearing race concentrically mounted adjacent to the periphery of said second plate; (e) an output plate rotatably mounted on said second plate by way of said bearing race and a set of bearings; and (f) a star compound gear train disposed in said housing, said star compound gear train including first and second gear train modules, wherein said first gear train module meshes with said second gear train module, wherein said first gear train module includes a star compound gear train and is driven by said rotor, and wherein said second gear train module drives said output plate.

In another aspect, a rotary actuator is provided which comprises (a) a first clutched star compound gear; (b) a second clutched star compound gear; (c) an output attachment plate which rotates about a central axis; (d) an outer attachment shell; and (e) a principal bearing having a first surface which is attached to said output attachment plate, and a second surface which is attached to said outer attachment shell; wherein said output attachment plate has a first major surface; and wherein said output attachment plate, said outer attachment shell and said principal bearing are arranged such that a first line exists which is perpendicular to said first major surface of said output attachment plate and which passes through said output attachment plate, said principal bearing and said outer attachment shell, and wherein said first line is parallel to said central axis.

In a further aspect, a rotary actuator is provided which comprises (a) a star compound gear train; and (b) a clutch which transforms said star compound gear train between a first mode of operation in which the gear train operates at a first gear ratio, and a second mode of operation in which the gear train operates at a second ratio.

In still another aspect, a rotary actuator is provided which comprises (a) a star compound gear train; and (b) a clutch which transforms said star compound gear train between a first mode of operation in which the gear train operates at a first gear ratio, and a second mode of operation in which the gear train operates at a second ratio.

In yet another aspect, a heavy duty construction vehicle is provided which comprises (a) at least one load bearing element selected from the group consisting of beams and arms; (b) a gear train including first and second gear train modules, wherein said first gear train module meshes with said second gear train module, wherein said first gear train module includes a star compound gear train, and wherein said second gear train module includes a simplified parallel eccentric gear train; and (c) a prime mover which drives said at least one load bearing element by way of said gear train.

### DETAILED DESCRIPTION

### I. Introduction

There is currently a need in the art for a plug-and-play architecture for land vehicles based on self-contained multi-speed in-wheel drives. Beyond this immediate application, there is also a general need for low cost plug-and-play 2 and 4-speed transmissions for machines. These needs may be met with the devices, systems and methodologies disclosed herein.

In particular, in-wheel drives for land transport vehicles (cars, fleet vehicles, trucks, trains, farm and construction machinery, robots, motorcycles, and the like) are disclosed herein. These in-wheel drives (sometimes referred to herein as electrical Multiple-speed Drive Wheels, or eMDWs) may be rapidly scaled in size and cost to enable rapid plug-in for all electrically powered vehicles. This plug-in approach allows an open architecture for rapid assembly, repair, and refreshment while enhancing performance and lowering cost. This overall design concept can be used for low cost, two-speed transmissions. Putting two in-series makes a very compact, concentric 4-speed transmission.

In one particular embodiment disclosed herein, an eMDW is provided for automobiles which is based on electrical two-speed in-wheel drives offering 500 ft-lb. peak high density output torque to result in acceleration of 0 to 30 mph in 2.28 sec. and 0 to 60 mph in 8.6 sec. The in-wheel drives in this embodiment may help to reduce vehicle weight to 3000 lb. (from 3600 lb.), uses a 40 kwh battery package and still maintains a range of about 250 miles. This embodiment also offers significant cost reductions, partly because of the low cost driveline and reductions in the cost of batteries over the past few years.

The eMDWs disclosed herein are also especially advantageous for use in motorcycles. Several motorcycle producers (such as, for example, Alta, Harley-Davidson and Indian) are producing (or planning to produce) electric drive motorcycles with a view toward providing greater efficiency and reduced noise. The dominant requirements for eMDWs in this application include high early acceleration (0-60 mph in 3 seconds) and outstanding gradeability (off-terrain, hill climbing). It is now possible to offer a 2-speed rear wheel plug-in module of 250 to 500 ft-lb. torque capacity with a 0-to-60 acceleration for 5 down to 3 seconds and do so in packages weighing 25 to 50 lb. (or less).

There are 13 basic structural, shaft, and gear parts to a preferred embodiment of the eMDW 2-speed gear reducer disclosed herein. One important component of this embodiment of the eMDW is its strong back wall, which ensures exceptional structural integrity, high stiffness and ruggedness, and thus enables weight reduction.

Another important component in this embodiment is the dog-leg clutch, which rides on the central shaft spline to drive either the low or high pinion gears for high and low speed operation. These gears then drive meshed star gear shafts, which in turn drive the output star gears, which mesh with the final internal gear on the gear bearing (this final internal gear is the output of the eMDW). The simplicity of this arrangement minimizes weight, inertia, deformation, and cost. The use of precision assembly surfaces enables rapid assembly while maintaining a unified concentricity for all parts in the eMDW.

A further important component in this embodiment is the principal bearing, which is preferably disposed between the strong back wall and the output to the disk brake and wheel rim. This bearing may be a ball, a cross roller, or a grooved roller bearing, depending on the cost/benefit of a given application. This unique combination of a principal bearing and internal gear is the final output of a set of low complexity actuators which may be used in a very wide range of applications (car in-wheel drives, robot manipulators, wind turbines, heavy transport, buses, fleet vehicles, and the like). This compact structure may be produced as a low weight structure which is stiff in all directions, which enables quick attachment to the reference frame, and which may be mass produced in large quantities either using, for example, ball bearings, cross roller bearings, or grooved roller bearings.

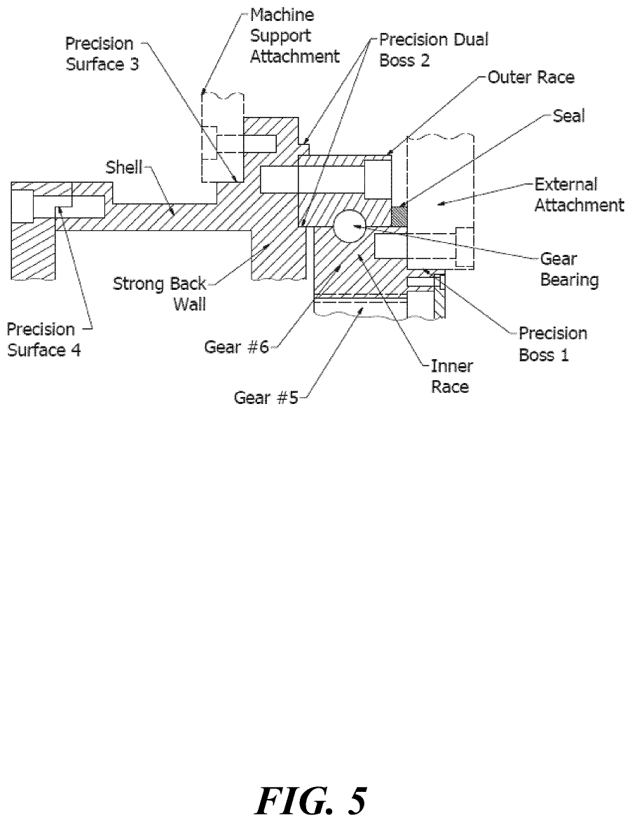

Concentricity of all components of the multi-speed drive wheel (MDW) about its central axis is preferred in order to ensure rapid assembly. This may be achieved by using a finite number of “standard” precision interfaces (bosses) for structural integrity (bolted to hold in place) with minimum in process uncertainty (see FIG. 5).

The MDW disclosed herein is a reasonably complete design which may warrant further refinement after building and testing the prototype. The use of star compound gearing in preferred embodiments of this design results in a central shaft with no radial loads. Consequently, the shaft bearings primarily provide concentric operation for the star gears. The star gears (usually 3) do experience a mesh force which must be carried by the shaft bearings (usually quite low in magnitude). These gears carry peak and continuous loads. In this case, gear widths of about 0.5″ may provide very useful safety factors (the lowest is 1.4 for peak bending and 1.1 for peak contact stress for mesh 2). Increasing the width of mesh 2 to 0.6″ results in safety factors of 1.6 and 1.2, respectively, even at peak loading which is expected to occur 1% of the time for most duty cycles. Normally, continuous loading would result in very safe factors of 4 and 2, respectively. Note, also, that the last mesh 3 (gears 5, 6) provide safety factors of 1.3 and 1.5 for bending and contact stresses under peak loading. For continuous loading, these factors raise to 3.3 and 2.3, which should guarantee very high durability (say, 20,000 hours or 1,000,000 miles of vehicle travel) and enable considerable flexibility in future design to reduce weight and cost.

All principal parts of a preferred embodiment of an eMDW are disclosed herein and are depicted with precision assembly surfaces. One skilled in the art will appreciate the manner in which permissible interference fits may be utilized to produce a tight and realistic assembly of the eMDW. In a preferred embodiment of the eMDW, the gears all helical gears with 30° helix angles and 25° pressure angles, which should enable standard machining. Some care may be warranted for gear surface finish and hardening to reduce friction and stiction. In some applications, the motor shaft may need to be splined to fit into the input splined shaft. The motor shell may also need to be bolted to the MDW gear structure (no real loading is expected).

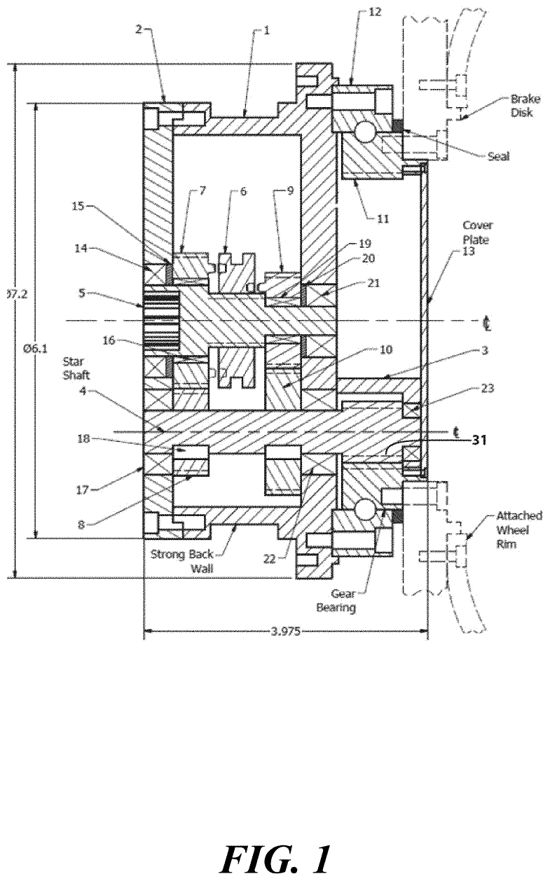

Most of the bearings (14-23) utilized in the eMDWs disclosed herein are described with nominal dimensions intended to guide those skilled in the art in choosing bearings, dimensions, and fits to serve the best needs of the prototype. Bearing 23 (see FIG. 1) supports the outer portion of the star shaft (part 5) which is 0.4″ in diameter in a preferred embodiment. This bearing should fit into the inner diameter (0.8″ in a preferred embodiment) of the internal cage wall and, in a preferred embodiment, is 0.25″ wide.

The precision internal cage wall may be a complex machined part. It may be bolted to the internal strong back wall to support the star shaft/gear when it meshes with an internal gear to minimize mesh distortion due to external loading on the gear bearing. Preferably, the precision internal cage wall is about 0.1″ longer along the bearing 22 axial direction to fit into a 0.1″ machined inset so the precision fit assembly maintains concentricity and does not shift during heavy loading.

### II. The Development of Electric Drivelines for Small and Medium Scale Transport Vehicles

### A. Overview

There is a continuing urgency to develop cost-effective and energy-efficient electric drivelines for cars and other light vehicles. Most electric vehicles on the market are at the high end (Tesla, Jaguar, Mercedes), with some attempt towards mid-price units (Volt, Bolt, Prius). Key technologies for these vehicles include the synchronous AC and the brushless DC motor. These components drive a gearbox and create sufficient wheel torque to effectively accelerate the vehicle. A few examples of vehicles are known which have motors in the wheels. However, these vehicles tend to be too heavy or too expensive. Weak in-wheel examples of a motor and one-speed gearbox have resulted in low torque-to-weight ratios. Some of the developments of these efforts to-date are documented herein, and a move is forecasted towards a plug-and-play architecture based on self-contained multi-speed in-wheel drives, thus enabling rapid assembly repairs and updates from a competitive supply chain.

B. Cost Reduction of a Chevy Bolt to ACTU8TR 4-Trac, Four 2-speed Tesar Wheels

The in-wheel drives disclosed herein have the potential to revolutionize the electric automobile industry. In a preferred embodiment, these electrical two-speed in-wheel drives offer 500 ft-lb. peak high density output torque to result in acceleration of 0 to 30 mph in 2.28 sec. and 0 to 60 mph in 8.6 sec. A typical vehicle utilizing these drives would see a weight reduction from 3600 lb. to 3000 lb., use a 40 kwh battery package and still maintain range of 250 miles. Moreover, significant reductions in the cost of the vehicle may be realized as a result of the low cost driveline and recent reductions in the cost of batteries.

### C. Development of a Plug-in Rear Axle 2-Speed Drive for Motorcycles

Several motorcycle producers (Alta, Harley-Davidson, Indian, etc.) are now producing (or have plans to produce) electric drive motorcycles for greater efficiency and reduced noise. Dominant requirements are high early acceleration (0-60 mph in 3 sec.) and outstanding gradeability (off-terrain, hill climbing). It is now possible, using the in-wheel drives disclosed herein, to offer a 2-speed rear wheel plug-in module of 250 up to 500 ft-lb. torque capacity with a 0-to-60 acceleration for 5 down to 3 seconds, and do so in 25 to 50 lb. (or less) packages.

### D. Parts Description for the MDW Prototype

There are thirteen basic structural, shaft, and gear parts to the preferred embodiment of the eMDW 2-speed gear reducer disclosed herein. An important component of this device is the strong back wall, which ensures exceptional structural integrity, high stiffness and ruggedness, and which enables weight reduction.

Another important component of this device is the principal bearing between the strong back wall and the output to the disk brake and wheel rim. This bearing may be a ball bearing, a cross roller bearing or a grooved roller bearing, depending on the cost/benefit of a given application. This multi-role component dramatically reduces complexity, reduces parts count, increases stiffness, and improves power/torque density while reducing cost.

A further significant component of this device is the dog-leg clutch, which rides on the central shaft spline to drive either the low or high pinion gears for high and low speed operation. These gears then drive meshed star gear shafts, which in turn drive output star gears. The output star gears mesh with a final internal gear on the gear bearing, which forms the output of the eMDW. The simplicity of this design minimizes weight, inertia, deformation, and cost. The preferred use of precision assembly surfaces enables rapid assembly while maintaining a unified concentricity for all parts in the eMDW, thus enabling scaled designs for cost effective minimum sets.

### E. Principal Gear Bearing for MDW

In a preferred embodiment of the MDW disclosed herein, a unique combination of a principal bearing and internal gear forms the final output of a remarkable set of low complexity actuators that may be used in a very wide range of applications. Such applications include, for example, car in-wheel drives, robot manipulators, wind turbines, heavy transport, buses, fleet vehicles, and the like. This compact structure is preferably stiff in all directions, very low weight, enables quick attachment to the reference frame, and is amenable to mass production. The principal bearing may be implemented as a ball bearings, cross roller bearing (without additional axis support bearings), or grooved roller bearing.

### F. Rapid/Precision Assembly of MDW

Concentricity of all components of the multi-speed drive wheel (MDW) about its central axis is desirable in order to ensure rapid assembly. This may be achieved, for example, by using a finite number of “standard” precision interfaces (bosses) for structural integrity (bolted to hold in place) with minimum in process uncertainty (see FIG. 5). This enables size scaling to form minimum sets provided by a competitive supply chain at minimum cost.

### G. Description of Prototype Design Process

The preferred embodiment of the MDW disclosed herein has now culminated in a reasonably complete design which may nonetheless warrant further refinement after further prototype development. The star compound gearing results in a central shaft with no radial loads so the shaft bearings are primarily providing concentric operation for the star gears. The star gears (preferably 3) do experience a mesh force, which are carried by the shaft bearings (usually quite low in magnitude). These gears carry peak and continuous loads. In this case, gear widths of 0.5″ may provide very useful safety factors (the lowest is 1.4 for peak bending and 1.1 for peak contact stress for mesh 2). Increasing the width of mesh 2 to 0.6″ may result in safety factors of 1.6 and 1.2, respectively, even at peak loading which is expected to occur 1% of the time for most duty cycles. Normally, continuous loading would result in very safe factors of 4 and 2, respectively. Note, also, that the last mesh 3 (gears 5, 6) may provide safety factors of 1.3 and 1.5 for bending and contact stresses under peak loading. For continuous loading, these factors raise to 3.3 and 2.3, which should guarantee very high durability (say, 20,000 hours or 1,000,000 miles of travel) and enable considerable flexibility in future design to reduce weight and cost.

H. eMDW Prototype Drawings/Descriptions

One skilled in the art will appreciate from the present disclosure how to machine and assemble embodiments of the eMDW gear reducer disclosed herein. The motor shaft is preferably splined to fit into the input splined shaft. The motor shell is also preferably bolted to the MDW gear structure (no real loading is expected). All principal parts are depicted with precision assembly surfaces. One skilled in the art will appreciate how the permissible interference fits to enable a tight and realistic assembly.

In the preferred embodiment of the MDW disclosed herein, the gears are preferably all helical gears with 30° helix angles and 25° pressure angles, which may enable standard machining. Some care may be warranted for gear surface finish and hardening to reduce friction and stiction.

Some of the bearings in the MDW disclosed herein are described with nominal dimensions intended to guide those skilled in the art in choosing bearing types, dimensions, and fits to serve the best needs of the prototype. Bearing 23 (see FIG. 1) supports the outer portion of the star shaft which is preferably 0.4″ in diameter. In a preferred embodiment, it is fit into the inner diameter of 0.8″ of the internal cage wall and is 0.25″ wide.

In some embodiments, the precision internal cage wall is a complex machined part. It is preferably bolted to the internal strong back wall to support the outer end of the star shaft/gear when it meshes with the internal gear to minimize mesh distortion due to external loading on the gear bearing. In a preferred embodiment, it is 0.1″ longer along the bearing 22 axial direction to fit into a 0.1″ machined inset so the precision fit assembly maintains concentricity and does not shift during heavy loading.

### III. The Development of Electric Drivelines for Small and Medium Scale Transport Vehicles

### A. Background

Generally, previous development has concentrated on the electric prime mover with a small effort on the mechanical gearbox to create a balanced driveline tech base. This imbalance then results in centralized E-axles (motor and one-speed gearbox) which offers no modern choices (safety by torque vectoring, no single points of failure, cost-effective supply chain component production, etc.) and does so at premium prices. The TU Milan in 2016 prototyped a simple driveline that offered a useful torque/weight ratio of 1.5 ft-lb/lb. (peak) and 1.0 ft-lb/lb. (continuous). On the other hand, the Colorado School of Mines (in 2002) built a low cogging prime mover with a low 0.25 ft-lb/lb. Tokyo University with Mitsubishi (in 2010) developed a 66 h.p. 160 lb. motor with a 1.88 ft-lb/lb. ratio. The Tesla driveline offers an estimated low ratio of 0.32 ft-lb/lb. By contrast, Ecomove uses an offset gearbox with a prime mover up to 18,000 RPM and a peak torque/weight ratio of 7.5 ft-lb/lb. Also, an aggressive company, YASA, offers one and two-motor drivelines which nominally offer 2.86 ft-lb/lb. peak with a high end offering with 3.43 ft-lb/lb. For trucks, EATON offers a gearbox with 4 speeds driven by a separate electric prime mover to improve drive cycle efficiency by 30%. Finally, extensive tabulation on recent vehicles have power-to-weight drivelines with a range from 1 to 6 h.p./lb. In terms of total vehicle weight per horsepower, the range starts at 66 lb/h.p. for diesel locomotives to 7.1 for the Tesla and a low 3.2 for the high performance Ferrari.

### B. Recent Development of In-Wheel Drives:

It now becomes essential to move the traction power directly inside the wheel (2 to 4 wheels) to maximize efficiency, minimize weight, and to reduce lifecycle cost. Nissan (in 2009) has shown that an in-wheel axial BLDC motor would provide reasonable torque/weight ratios of 2.0 to 0.57 ft-lb/lb. (zero to 6000 RPM, uncooled) and 2.5 to 1.22 (cooled) from low to high speed. Note that the cooling benefit ratio goes from 1.25 to 2.14 because of the higher power levels at higher speeds. An extensive comparison of principal prime mover classes results in the following numerical ranking:
IM(27), PM(25), SRM(23), DC(22).
   Generally, these results apply to larger cars. The DC may be the best for small-scale vehicles. A four-wheel vehicle in Singapore provides 6 ft-lb/h.p., while a University of Tokyo team, in 2005, developed a 444 ft-lb. peak torque in a wheel drive.

### C. Two-Speed, In-Wheel Drive

A rugged, low-cost, 2-speed electric wheel drive (eMDW) of exceptional performance and durability is disclosed herein which can be implemented in 40 lb. (and 20 h.p.) and 70 lb. (and 40 h.p.) configurations that are sufficiently light weight to not require active (and expensive) suspensions for light to medium weight personal and commercial vehicles. This distributed transmission minimizes weight and complexity in the rest of the vehicle while placing the power as close as possible (minimum drive inertia) to the required active wheel traction force. By contrast, an alternate all-electric wheel drive is available at much higher weight, high cost, low output torque, and very small air gap unprotected against shock by a small axle bearing. The power density of the eMDW described here exceeds the pure electric by 3×, provides a reduced cost of 4×, improves ruggedness by 5×, and provides an energy loss reduction 2× better because of operation at all times in its efficiency sweet spot (either electrically or mechanically).

The following is an abbreviated listing of the unique features of this device (sometimes referred to herein as the Tesar Wheel) and its impact on open architecture light vehicles of the future.

TABLE 1
Attributes of the Tesar Wheel

| Attribute | Description |
|---|---|
| Cost | Plug-and-play energizes the supply chain to |
| (<50%) | reduce driveline cost by more than 50%, |
| | enabling standardization an in-depth |
| | certification. |
| Weight | No axles, torque tubes, central transmissions, |
| (<50%) | clutches, etc., all weight is in the wheels to |
| | reduce driveline weight by more than 50%, |
| | enabling 20% increase in vehicle range. |
| Efficiency | 32 alternate configurations enable continuous |
| (≈95%) | operation in prime mover sweet spots to |
| | always operate near 95%, an increase of up |
| | to 30% and range increase by 30%. |
| All Scales | Drive wheel can be scaled to all sizes of |
| (light to | vehicles, motorcycles, cars, trucks, buses, |
| heavy) | locomotives, construction, etc., used in all |
| | measures of power, torque, weight, etc. |
| Torque | Improves torque density over alternate |
| Density | solutions by 3x providing fast starts (very |
| | low internal inertia), excellent gradeability, |
| | and minimizes unsprung weight. |
| Ruggedness | Exceptional ruggedness to resist shock in |
| | all directions with all bearings in stationary |
| | strong back wall structures, to result in |
| | durability for up to 1,000,000 miles. |
| Two Speeds | Provides two speeds for best performance |
| | management with a latch solenoid dog-leg |
| | clutch for 10 to 30 msec. gear switching, |
| | enabling rapid system reconfiguration. |
| Simplicity | Minimum of parts, simple gearing, separate |
| | motor gear train volumes, precision mounting |
| | surfaces, with standardization/scaleability to |
| | reinforce supply chain competitiveness. |
| Vehicle | Enables separate ladder frame, car body, |
| Architecture | plug-in batteries, standardized interfaces, |
| | assembly on demand based on customer- |
| | oriented recomputer apps, enables rapid |
| | assembly, repair, and freshment/up-dates. |
| Decision | Enables continuous development of a |
| Structure | customer prioritized criteria-based decision |
| | software structure to automatically respond |
| | to all efficiency, safety, weather, terrain, etc. |
| | conditions. |

### IV. Cost Reduction of $40,000 Chevy Bolt to ACTU8TR 4-Trac Using Four 2-Speed Tesar Wheels

### A. Objective

It is a goal of the present disclosure to provide an in-wheel drive system that may be utilized to revolutionize the electric automobile industry. This may be accomplished through use of the electrical two-speed in-wheel drives disclosed herein which, in a preferred embodiment, offer 500 ft-lb. peak high density output torque to result in acceleration of 0 to 30 mph in 2.28 sec. and 0 to 60 mph in 8.6 sec. In one particular embodiment, car weight is estimated to go down from 3600 lb. to 3000 lb., use a 40 kwh battery package, and still maintain range of 250 miles. Moreover, market price of the vehicle is expected to be reduced by about 40%, partly because of the low cost driveline and reducing cost of the battery (by about 50% per kwh) over the past few years.

The technical development of the personal computer history is a good model to guide the future development of open architecture modular high-performance/low-cost cars. Dell Computers, Intel and Microsoft formed a triad in the 1980s to accelerate the development of PCs with an emphasis on standardized modules that could be fully certified and rapidly assembled and then provided in a competitive supply chain, always improving performance and reducing cost of all hardware and software components.

Unfortunately, today's auto industry is still trapped in a one-off build/sell/repair process based on a closed architecture reinforced by long-term supply contracts. Nonetheless, the electric car structure is far different from that of the ICE-based car with a minimal collection of far simpler component modules, increasingly standardized interfaces, emerging cost-effective batteries, etc. The critical issues remain vehicle cost (high battery cost and weight) and limited range (exceptions are above 200 miles).

The systems and methodologies disclosed herein provide a means by which vehicle costs may be reduced by 40% based on a minimum array of standardized modules that can be assembled, repaired, and refreshed on demand, thus providing drivelines that are scalable in terms of, for example, durability, gradability, range and efficiency. Most EVs today have one-speed or two-speed E-axles to drive one or both axles with no openness, high cost, no torque vectoring, and limited concern for single-point failures. Given the goal of openness, it is preferred that all basic car modules are chosen by the customer (using supporting open market apps) before purchase. These same apps will guide time-efficient repairs (by plug-and-play), and also offer guidance on up-dates (refreshments) by changing out original modules (put on the market for resale) and inserting higher performance modules (when the customer has adequate resources).

### B. Open Architecture/Modularity

It is preferable that the modular vehicles disclosed herein are capable of being assembled on demand. The car body is a key component which includes, for example, the skin, paint, doors and windows, which will be aesthetic choices by the customer. Similarly, the comfort interior (such as, for example, the seats, dash, flooring and ceiling) will also be somewhat aesthetic. Finally, the “Com” system (including, for example, communications, radio, GPS and driving support for safety) will be of high interest to the customer. The car's range will be basically decided based on how much the customer wishes to spend for the battery. Finally, the car's drivability (acceleration, efficiency, safety, etc.) will be governed by the in-wheel drive technology where its associated durability (from 250,000 to 1,000,000 miles) will be cost choices made by the customer.

TABLE 2 sets forth the modules and their expected weight and costs, based on current prices and an assumed basic car cost of $24,000:

TABLE 2
Vehicle Component Weight and Cost

| Item | Cost ($) | Weight (lb.) | Description |
|---|---|---|---|
| Car Body | 7000 | 1000 | Body, Paint, Doors, |
| | | | Windows, Trim |
| Comfort Interior | 2000 | 400 | Seats, Dash, Floor, |
| | | | Ceiling |
| Communication | 1500 | 30 | Radio, GPS, Driving |
| Links | | | Support |
| CPU | 1000 | 20 | Central Processing |
| | | | Unit, OS, Decision |
| | | | SFW |
| Cooling System | 1560 | 100 | Air Conditioning, |
| | | | Battery/Driveline |
| Ladder Frame | 600 | 250 | Structure To Tie All |
| | | | Modules Together |
| Suspension | 800 | 120 | Springs, Shocks, |
| | | | Links, Steering |
| Wheels | 800 | 100 | Tires, Brakes, |
| | | | Wheels |
| Battery | 5200 | 640 | Upgradable In |
| (40 kwh) | | | Basic 10 kwh |
| | | | Modules |
| In-Wheel Drive | 3600 | 200 | Four 2-speed |
| | | | Modules with |
| | | | Inverters |
| Totals | 24,000 | 3,000 | |

As shown in TABLE 2, a cost reduction of 40% is feasible for a car which gives the customer life-long choices to best meet their transportation needs.

### IV. Development of a Plug-in Rear Axle 2-Speed Drive for Motorcycles

### A. The Overview:

Several motorcycle producers (such as, for example, Alta, Harley-Davidson and Indian) are now (or will be) producing electric drive motorcycles for greater efficiency and reduced noise. Dominant requirements for this application are high early acceleration (0-60 mph in 3 sec.) and outstanding gradeability (off-terrain, hill climbing).

A 2-speed rear wheel plug-in module may be produced in accordance with the teachings herein which provides 250-500 ft-lb. torque capacity with a 0-to-60 acceleration for 5 down to 3 seconds. This may be accomplished in packages weighing 25 to 50 lb. or less.

### B. Electric Motorcycle Development

Several companies currently offer (or are developing) E-bikes to reduce urban noise and to enhance efficiency. For example, Harley Davidson (H-D) currently offers a 500 lb. bike called the Livewire with 58 ft-lb. torque, 0-60 mph in 4 sec., range of 55 miles, 74 hp, up to 92 mph, cost of $13,000 with 10 kwh battery (⅙ of that in the Bolt). Zero is a competitive racing company with an E-bike having 70 hp, 116 ft-lb., a top speed of 204 mph, and a cost of $20K. Their EGO is 145 hp, 198 ft-lb., 200 h.p., up to 150 mph, cost of $34K. Lightning offers 100 mile range, 168 ft-lb., 200 h.p., 10,500 RPM motor, 495 lb. weight. Yamaha specializes in low cost electric bikes for Asia. Polaris recently acquired BRAMMO, but hasn't produced new bikes (they make lower cost ATVs). Suzuki produces multiple type bikes. One may have an electric motor in the rear wheel.

### C. Proposed E-Motorcycle Development:

Alta Motors has produced the Redshift MX E-bike. This vehicle has the parameters set forth in TABLE 3:

TABLE 3
Redshift MX E-Bike Parameters

| Parrameter | Description |
|---|---|
| Range | 3 hours continuous use |
| Top Speed | 65 mph |
| Torque | 120 ft-lb., 3.5-to-1 gearing |
| Weight | 267 lb. |
| Battery | 68 lb., 5.8 kwh, 350 v |
| Motor | 15 lb., 50 h.p., 14,000 RPM |
| | PMAC liquid cooled |

A preferred embodiment of the in-wheel drives disclosed herein offers two speeds in a plug-in module for the rear wheel. This eliminates any drive chain, centralized transmission, and foot engagement lever. In general, expected drive weights, torques, and acceleration periods to 60 mph are as indicated in TABLE 4:

TABLE 4

| | Tesar Wheel E-Bike Parameters | | |
|---|---|---|---|
| | Weight | Torque | Accel. |
| | (lb.) | (ft/lb.) | Time (sec.) |
| Light | 25-28 | 280 | 5 |
| Medium | 35-38 | 350 | 3.3 |
| Large | 50 | 500 | 2.7 |

The larger scale bike may be equivalent to the Redshift's present weight of 267 lb. The acceleration time estimates are based on a rider of 183 lb. weight for a system total weight of 450 lb. for the larger system. The present ALTA PMAC motor is a precision and expensive prime mover. It is recommended that a less expensive BLDC PM motor be given consideration with a top RPM value near 6000, which may bring down cost and still provide adequate durability, torque density, and efficiency for this market.

### V. Parts Description for MDW Prototype

### A. Overview

FIG. 1 depicts a particular, non-limiting embodiment of an MDW in accordance with the teachings herein. With reference thereto, the MDW depicted includes a shell 1 which is attached to, and provides support for, a strong back wall 2. The back wall 2, in turn, provides support for the press fit of the star gear shafts 4. This element, which is sometimes referred to as the backbone of the gear train, contains the shortest force path between the attachment support structure of the suspension system and the gear bearing 12 through to the brake disk and the attached wheel. This shortest force path provides maximum stiffness in the smallest volume of material and therefore minimum weight. This stiffness then leads to the least distortion or deformation of the internal working precision parts (such as, for example, the shafts, gears, bearings, and clutch). The embodiment of FIG. 1 may be contrasted with a typical implementation of epicyclic gearing which lacks a strong back wall and the advantages attendant thereto. As seen in FIG. 1, each of the key gears in this embodiment is equipped with a bearing element. While this is greatly preferred, embodiments of the MDW are possible which omit this feature.

In a preferred implementation of the embodiment of FIG. 1, the strongback wall is 0.5″ thick with an outer diameter of 7.2″ and has a shell extension of 6.1″ in diameter to form a bolted closure with the back wall 2. This back wall may be a common structural element between the attached prime mover and the gear reducer structure. The support attachment benefits from a precision surface connecting the shell and the strongback wall. Another precision mounting surface is provided on the outer face of the strong wall to lock the outer race of the gear bearing 12 rigidly to the strongback wall. This is, in fact, a shallow groove with inner and outer precision surfaces (bosses) which prevents any relative motion for a tightly bolted assembly.

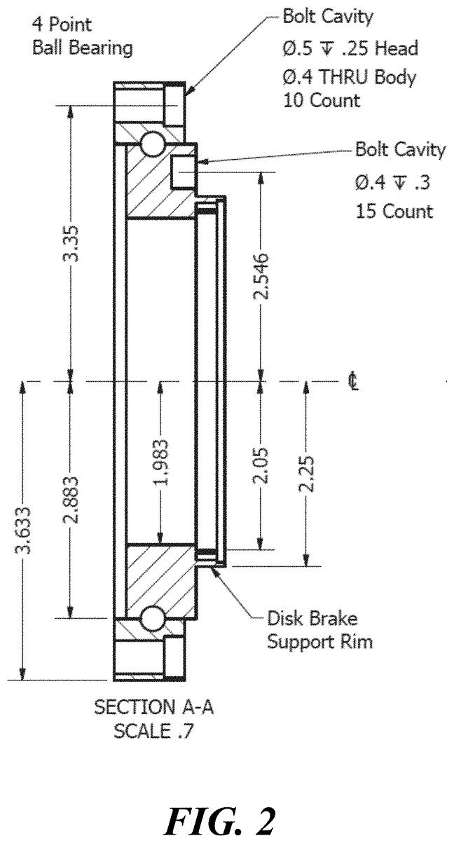

The strongback wall also provides support for the bearing 23 cage support 3 to strengthen the output star gears 31 that mesh with output gear 11 (the output gear 11 is shown in Greater detail in FIG. 2). The three star gear shafts 4 are supported by bearings 22 in the strongback wall 2 and shell.

Finally, the central pinion shaft 5 is supported at its centerline by bearing 21 on the MDW center line and a thrust bearing 20 to prevent its axial movement due to thrust forces on the helical teeth of the drive pinions 7, 9 supported by simple needle bearings 16, 19.

The back wall 2 is preferably in the form of a plate which provides closure to the gear train volume. It is attached with a precision lock surface to the shell 1 of the module to enable rapid, but precise, centering of the central pinion shaft 5, which is supported by ball bearing 14 and thrust bearing 15. Each of three star shafts 4 are supported in the back wall 2 with ball bearings 17. Note that bearing 14 experiences no radial forces since the radial forces on each of three star gears symmetrically cancel.

The MDW of FIG. 1 is equipped with a support bracket 3 for the outer bearing 23. The support bracket 3 is tabled on the outer star bearing support cage (or internal cage wall). It is rigidly attached with a small inset ring boss (preferably about 0.1″ deep) to the outer surface of the strong back wall 2. The backbone wall 2 thus provides extended rigid support to the outer bearings 23 via the bracket 3 to ensure that output star gears 31 on star shaft 4 are always correctly aligned with the mating gear teeth on the internal gear 11.

The 3 star gear shafts 4 of the MDW of FIG. 1 rigidly transfer torque from input star gears 8 and 9 to the 3 output star gears 31, which mesh with internal gear 11 on the inner race of the gear bearing. These star gears 31 are rigidly joined to star shafts 4 using straight (slightly tapered) keys 18. The back wall provides rigid ball bearing 17 support for the star gear shafts 4. The strong back wall provides rigid support on the other end of the star shaft using ball bearings 22. Bearings 22 and 23 on both sides of output star gear 31 gives it very rugged support from all external and driving forces.

The central pinion/clutch drive shaft of the MDW of FIG. 1 is a central shaft carries the first pinion 7 and second pinion 9, which separately mesh with sliding clutch 6. The input torque to the shaft from the motor is provided by an interference meshing spline. This torque is provided to a sliding spline between the clutch plate 6 and shaft 5. Clutch plate 6 engages dog legs to either pinion 7 or 9 to change the speed ratio (in this case, 3 to 1 to 6 to 1) of the MDW drive wheel. The pinion gears 7, 9 ride on the shaft 5 on thin uncaged needle bearings 16, 19 to enable them to free wheel when they are not engaged to the splined clutch plate 6. Note that these pinion gears are always in mesh with their mating star gears (7 to 8 and 9 to 10), thus making this free-wheeling necessary. In this case, the free-wheeling needle bearing surfaces may be hardened with surface treatment (although they carry no radial loads). Finally, each pinion gear 7, 9 is supported by thrust bearings 15 and 20 to resist the helical gear side forces on pinions 7 and 9. Finally, ball bearing 22 supports the far end of the pinion shaft in the strongback wall 1.

The first pinion gear 7 of the MDW of FIG. 1 is an input gear 7 driven by dog leg clutch plate 6 using dog leg meshes. Pinion 7 rides on a thin needle bearing to permit freewheeling when not connected to the clutch since it is always in mesh with star gears 8. Bearings 15, 16 provide radial and thrust force support for the pinion gear riding on shaft 5. In this case, the ratio of gear 7, 8 is 50% of that of the ratio of gears 9, 10, to give a 50% reduction (high speed gearing) at the output.

The second pinion gear 9, 10 of the MDW of FIG. 1 is greatly similar in function to gears 7, 8, where their ratio is twice that of gears 7, 8 to provide a 100% reduction (low speed gearings) at the output. Gear 9 is supported by needle bearing 22 and thrust bearing 20. It is driven by clutch plate 6 using mating dog legs between the two.

The MDW of FIG. 1 is further equipped with three star gears 8 on the front end of star shaft 4 rigidly attached by tapered square key 18. The three star gears 8 mesh with pinion 7 using 30° helical gear teeth (high torque transfer with less noise).

The second star gear 10 of the MDW of FIG. 1 is similar in purpose to star gear 8, except that it is sized to provide twice the reduction ratio with gear 9 as that provided by gears 7, 8 (for low speed operation). It is attached to star shaft 4 using a tapered key 18.

The gear bearing of the MDW of FIG. 1 is made up of an internal gear 11 and an outer race 12. A unique interface between these races could be a ball bearing as shown, or a cross roller bearing, or a grooved roller bearing, depending on the requirements for cost, rigidity, load capacity, weight, volume, and force management in all directions. Along with the strongback wall, this is perhaps the second most important component in the MDW gear module. It permits maximum performance with least complexity (attachments, bolt circles, standardized interfaces, and the like). The inner race has two critical functions. It carries the helical teeth of the output internal gear 11 to transfer the torque load to the disk brake and its attached wheel. The disk brake is bolted to the inner race and rides on a precision boss integral to the inner race. The disk brake then holds a bolted wheel rim riding on another precision boss as an integral part of the disk brake (or, the first precision boss could be extended to also support the wheel rim with a separate set of through-mounting bolts).

The outer gear bearing race 12 of the MDW of FIG. 1 is preferably rigidly attached to the strongback wall 1. This is preferably achieved at relatively low cost through the use of shallow concentric precision “bosses” which are cut into the strongback wall. The outer race may then be press fitted into these concentric bosses and bolted to secure the attachment. It will be appreciated from the foregoing that the simple rigidity from the attachment frame (from the suspension) through to the outer wheel rim is very high and necessarily shock resistant. This simplicity enables this MDW gear module to be easily scaled both in size and in cost, making supply chain management in minimum sets cost effective and manageable on a worldwide scale.

The cover plate 13 of the MDW of FIG. 1 is bolted to the outside boss of the rotating inner race 11 to provide a tight enclosure for the module's lubricant. In the same sense, a single lubricant seal exists between the outer race and the bolted on disk brake.

The MDW clutch in the MDW of FIG. 1 is preferably driven electronically. In some embodiments, it may be driven mechanically with a classic swing lever or driven by a 3-position latch solenoid. TLX Technologies appears to have a feasible solenoid for this purpose which is said to be good for 100 million cycles. This solenoid is said to be capable of operation at relatively high temperatures up to 500° F. It latches in two end positions (necessary for the clutch) and can hold a central spring loaded neutral position. The specifications are set forth in TABLE 5.

TABLE 5
Solenoid Specifications
(TLX Technologies)

| Specification | Value | |
|---|---|---|
| Stroke | <0.25 | in. |
| Latching Force | 10 | lb. |
| Response Time | <8 | ms |
| Centering Force | 3 to 4 | lb. |
| Current | 12 | amps (max) |
| Coil Resistance | 5 | ohm |
| Diameter | 1.024 | in. |
| Body Length | 1.40 | in. |
| Boss Length | 0.506 | in. |
| Boss Diameter | 0.620 | in |
| Shaft Diameter | 0.118 | in. |
| Shaft Length | 0.632 | in |

The TLX literature suggests flexibility to produce solenoids to fit a given application. The above specifications may fit within the present MDW prototype with some modification of the cage support structure. The unit would be centered between two star axes to avoid contact with the second set of star gears 18 next to the strong back wall 1.

### VI. Principal Gear Bearing for MDW

### A. Purpose

In a preferred embodiment of the systems and devices disclosed herein, the unique combination of a principal bearing and internal gear is the final output of a remarkable set of low complexity actuators used in a very wide range of applications (car in-wheel drives, robot manipulators, wind turbines, heavy transport, buses, fleet vehicles, and the like). This compact structure is stiff in all directions, very low weight, enables quick attachment to the reference frame, and can be mass produced in large quantities either using a ball bearing, a cross roller bearing, or a grooved roller bearing.

### B. Principal Features

This combination of a large diameter bearing and a helical gear on its inner race (see FIG. 2) becomes the final reduction of a low complexity actuator to drive a wide range of output functions under complex loading (torque, external moments, radial and loads). Preferably, the MDW has the ability to sustain shock in all directions. This may be accomplished by having the outer race of the bearing attached to a rigid reference frame (of the machine it drives), and having the inner race attached to the output structure of the machine. This creates a shortest force path, which transfers load forces primarily through compression. It is noted that bending is conceptually 750× more compliant and torsion is 2500× more compliant than compression in terms of the same structure (say, a 1″×1″×10″ beam). This is why the final helical gear is preferably integral to the inner race, so it transfers load with minimal distortion to its output (say a wheel on a vehicle) which is also attached to the inner race. This shortest force path achieves maximum stiffness in the smallest volume and least weight, which is significant in all moving systems responding to command, and which also minimizes output inertia.

### C. Applications

Increasingly, more actuators will likely be required in machines under command (principally by humans) to maximize choice (such as, for example, speed, acceleration, load, path configuration, and disturbance rejection). This increased choice demands minimum deformation between input and output, and an increasing emphasis on quick response to command. For example, the gear-bearing could be the final stage of an in-wheel electric drive for all scales of vehicles. Then, in poor weather, torque management would be critical to maintain safety. Doing so requires the least inertia in the driveline to obtain quick response in torque/speed levels. The same gear bearing could be used in drive wheels for diesel electric locomotives, improving individual traction (without slippage) in a more reliable and lower weight driveline. This actuator could then be used in the last axle of a truck semi-trailer for torque vectoring to substantially reduce jackknifing. Overall, this gear bearing enables exceptional ruggedness and shock resistance in small volume and weight, which is critical to all moving vehicles. Each such driveline (wheel) would be independently controlled to maximize efficiency and life cycle durability. Given a set of 4 in-wheel drives (each with 5 distinct configuration choices) enables a set of 625 system configurations enabling all wheels to always remain in their efficiency sweet spot (usually 94-95%), far exceeding present electric vehicle drivelines.

### D. Gear Bearing Description

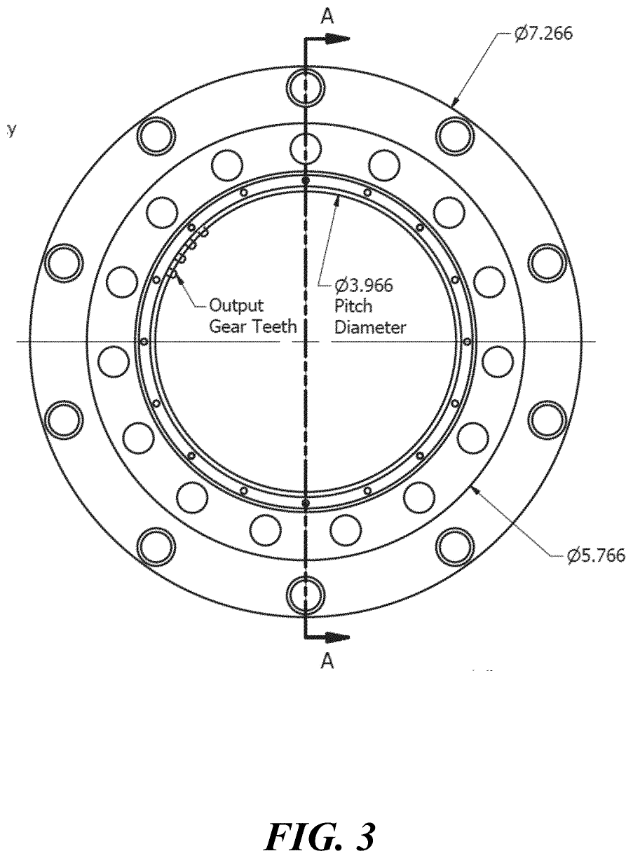

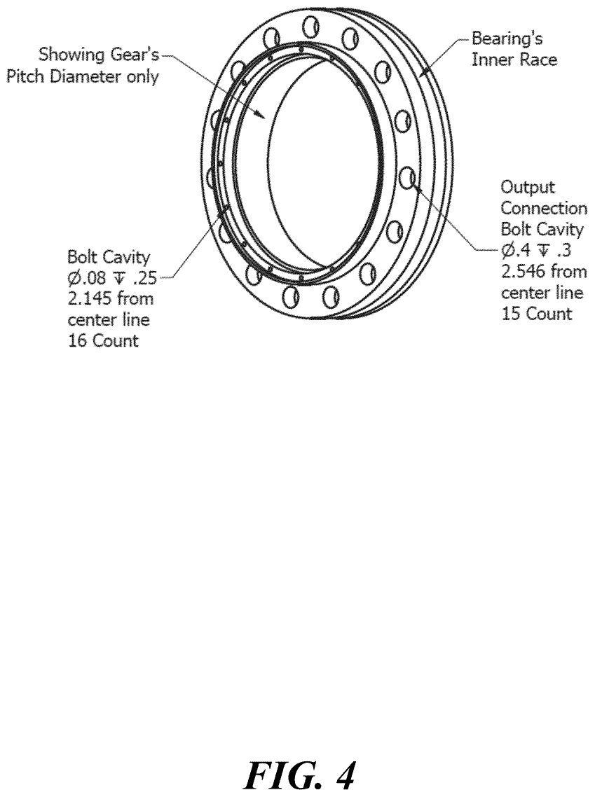

FIGS. 2-4 depict a preferred embodiment of the principal gear bearing. These drawings and the specifications therein are sufficient to permit the fabrication of this output module for a low-cost actuator (here intended to be an electric in-wheel drive). Generally, it is 7.266″ in outer diameter. The inner race contains the gear with a 3.966″ pitch diameter and a helical 30° angle with a pressure angle of 25°. All the basic dimensions for the inner race are given in TABLE 6 below including the gear parameters. The outer race also enables the use of a 0.30″ ball for the ball bearing. Of course, these generic numbers may be adapted or modified as necessary by the gear bearing producer to account for their manufacturing and test experience.

TABLE 6
Gear #6 Details (Normal Plane Configuration)
Gear #6 details (Normal Plane Configuration)

| | |
|---|---|
| Pressure Angle | 25° |
| Helical Angle | 30° |
| Diametrical Pitch | 20.377 |
| Teeth Count | 70 |
| Tooth Thickness | 0.077 in. |
| Face Width | 0.85 in. |
| Addendum | 0.061 in. |
| Dedendum | 0.049 in. |
| Root Diameter | 4.065 in. |
| Base Diameter | 3.595 in. |
| Pitch Diameter | 3.967 in. |
| Outside Diameter | 3.844 in. |
| Whole Depth | 0.106 in. |
| Working Depth | 0.098 in. |
| Clearance | 0.012 in. |

The generators (designers) of this layout are concerned about the sizing of the bolts to hold the races to their neighboring attachments. Clearly, shock is sporadically expected from all directions. Care has been taken to provide high radial shock resistance. However, out of plane moment shocks are preferably resisted by the inner and outer race bolts. Given experience by the bearing manufacturer, the inner and outer race may need to be increased in radial thickness to permit larger attachment bolts. Doing so would mean that the outer race attachment structure would have to change to accommodate the increased diameters of the outer race.

### VII. Rapid/Precision Assembly of MDW

### A. Overview

Concentricity of all components of the multi-speed drive wheel (MDW) about its central axis is required in order to ensure rapid assembly. This may be achieved by using a finite number of “standard” precision interfaces (bosses) for structural integrity (bolted to hold in place) with minimum in process uncertainty (see FIG. 5).

### B. Background:

Bolted assemblies depending only on tight friction locks are unpredictable for accurate location of mating parts (consider the NEMA standards for joining motors, gearing, drive shafts, etc.). By contrast, every existing commercial vehicle wheel is typically equipped with a precision boss to ensure axle concentricity and to prevent out-of-balance inertia forces from occurring. This enables assembly by non-trained individuals without special verification measuring methods. The same procedure may be used in the assembly and integration of the MDW into the vehicle's frame structure (suspension, brake disk, and wheel attachments). This enhanced precision assembly may enable quick low-cost plug-and-play repair/updates for the customer at any time during their ownership.

### C. Precision Interfaces:

FIG. 5 depicts a particular, non-limiting embodiment of the assembly of the MDW parts surrounding the gear bearing attached to the strongback wall to ensure high structural integrity (low deformation, ruggedness, and resistance to shock) through a shortest path of force transfer (from the support attachment frame to the external “wheel” attachment). This shortest force path passes directly through a large diameter gear bearing (which can be a 4 point ball configuration, a cross roller bearing, or a grooved roller bearing). The bearing necessarily represents some compliance, but it and the surrounding structural material minimizes that compliance, depending on the application requirements (such as, for example, cost, stiffness, volume and weight).

Each of the precision surfaces will have an interface tolerance depending on the level of desired press fit. For example, the wheel-brake disk interface may be a zero press fit to enable rapid wheel removal and replacement. On the other hand, the brake disk attachment to the gear bearing could be a significant interference press fit to ensure concentricity of the brake/wheel combination with the MDW's central axis.

### Sequence of Precision Surfaces

There are a total of 6 precision surface assemblies to put the MDW in place for a given vehicle “corner” (say, for a 4 MDW automobile). TABLE 7 includes a listing of these interfaces.

TABLE 7
Precision Surfaces

| Precision | |
|---|---|
| Surface | Description |
| Precision | Inner surface of disk brake interfaces |
| Boss 1 | with outer surface boss as part of the |
| | inner race of the gear bearing |
| Precision | Outer race of the gear bearing is dual |
| Boss 2 | press fit into an upper and lower boss |
| | machined into the outer surface of the |
| | strongback wall. |
| Precision | A precision surface on the MDW |
| Surface 3 | shell mates with the inner surface of |
| | the support attachment frame |
| | associated with the vehicle’s |
| | suspension structure. |
| Precision | The outer shell of the MDW may |
| Surface 4 | interface directly with the strongback |
| | wall or have the gear module back |
| | wall interface with an extended shell |
| | integral to the strongback wall. |
| Precision | The outer surface of the brake disk |
| Boss 5 | would carry a precision boss on which |
| | to mount the inner surface of the wheel. |
| Precision | The precision surface between the |
| Surface 6 | bearing cage for gear #5 and the strong |
| | back wall (not shown) is achieved by |
| | lengthening the cage by 0.1” to fit in a |
| | circular inset on the strong back wall |
| | outer surface. |

### XIII. Description of Prototype Design Process

### A. Introduction

This brief document serves as supplemental material explaining design decisions of an electrical Multi-Speed Drive Wheel with two speed transmission (eMDW). Key details presented here deal with gear geometry and loading, bearing requirements, and shaft dimensioning and loading. To best understand the design decisions, TABLE 8 illustrates the eMDW's expected performance.

TABLE 8
eMDW’s Expected Torque and RPM

| | | Electric Motor | | | |
|---|---|---|---|---|---|
| | | (eMDW Inputs) | | eMDW | |
| | | Max | Max | Output | eMDW Peak |
| Transmission | Gearing | Speed | Torque | Speed | Output Torque |
| Setting | Reduction | (RPM) | (lbf-ft) | (RPM) | (lbf-ft) |
| First Gear | 3 | 3,000 | 83 | 1,000 | 250 |
| (High-Speed) | | | | | (100 continuous) |
| Second Gear | 6.125 | 3,000 | 82 | 490 | 500 |
| (Low-Speed) | | | | | (200 continuous) |

As seen in TABLE 8, at First Gear, the gears engaged, the shaft and the clutch should be able to transmit 250 lbf-ft. Similarly, at Second Gear, the machine elements transmitting load need to do so without failure. Note the relatively low Max RPM of the expected prime mover, this is the case so that cost can be kept down. It does not mean that the motor can go up to 3,000 RPM, rather, it means that the motor's torque-velocity curve should have the highest torque around 3,000 RPM. The following sections go into brief detail of design for failure prevention.

### B. Gearing

This eMDW has three gear meshes, for ease of discussion they are define here:

TABLE 9
Gear Meshes Definition

| Mesh | Drive Gear(s) | | Driven Gear(s) | |
|---|---|---|---|---|
| Name | Name | Quantity | Name | Quantity |
| Mesh 1 | Gear #1 | 1 | Gear #2 | 3 |
| Mesh 2 | Gear #3 | 1 | Gear #4 | 3 |
| Output | Gear #5 | 3 | Gear #6 | 1 |
| Mesh | | | | |

Note that at times, Gear #2 and #4 are referred to as star gears, due to their star-like configuration. The shafts which hold these gears rigidly in place are sometimes called the “star shafts.”

The transmission settings defined in TABLE 9 are brought upon by the actuation of the clutch, which is engaging with either Gear #1 or #3. Gear #1 and #3 are special in that they have dog teeth in their faces which are used to engage with the clutch ring. When the clutch engages with Gear #1, Mesh 1 is engaged. Gear #1 drives three Star Gears #2. When the Clutch engages with Gear #3, Mesh 2 is engaged, Gear #3 drives three Star Gears #4. When the Clutch is in either engaged position, Gear #2 and #4, which are rigidly attached to the Star shafts, drive the three Star Gears #5, which drives output internal Gear #6.

Because Gear #2 and #4 are rigidly attached to the star shaft via keys, whenever either one's mesh is engaged by the clutch, the other will rotate freely, causing its driving gear (either Gear #1 or #3) to also rotate freely. This is the reason why needle bearing 16 and 19 are fitted between Gear #1 and #3, respectively, and the driving shaft.

Unlike planetary-gear trains, every gear axis in the preferred embodiment of the eMDW is fixed by bearings anchored in stationary wall structures and is only allowed to rotate about its own central axis. This offers a reduction of inertia as there are no multiple traveling gears or carrier frames, especially when there are multiple stages of reduction. Moreover, unlike configurations featuring two parallel offset shafts (as in most vehicle transmissions), the star configuration creates a balanced gear plane mesh with respect to load, thus reducing radial load on the bearings and bending moment on the central shaft. Furthermore, the transmitted load is distributed among three gears at each mesh. Load carrying capacity is further improved by the decision to make all gears to have a 30° helical angle.

### C. Gearing Selection Procedure

When either Mesh 1 or 2 is engaged, it makes a 1-Stage star compound gear train (SCGT) with the output mesh which is the gear bearing. Accordingly, each engagement is treated separately. In particular, calculations to find the geometry and loading of the gears when Mesh 1 is engaged are done separately from the calculations when Mesh 2 is engaged. However, these separate calculations are coupled by the fact that Mesh 1 and 2 must have the same center distance. The center distance depends on the gear mesh geometry (EQUATION 1), and it is 1.558″ for this specific gear train. Note that EQUATION 1 should only be used for Mesh 1 and 2.

Center Distance=pitch radius_{Driving Gear}+pitch radius_{Driven Gear} (EQUATION 1)

It is simpler to think of this in an assembly point of view. Both Mesh 1 and 2 use the same driving shaft and star shaft. The center distance is the distance from the center of the driving shaft to the center of the star shaft for each mesh. Because Mesh 1 and 2 share these shafts, they must have the same center distance. With this in mind and the requirements listed in the Introduction, the gear geometries and loads were calculated separately to meet the 200 and 500 lbf-ft peak load demands for each transmission setting. Mark's Handbook by Avallone et al, and Machinery's Handbook by Oberg et al. were used to get all the equations needed for helical gears. Every gear in this mesh has a helical angle of 30°, and a normal pressure angle of 25°. Note that, throughout the design, the normal plane configuration was used when calculating the geometry and loading of the gears. The reason for this is that the AGMA geometry factors tables (1989) use the normal pressure angle of a helical gear and standard spur gear cutting tools can be used when cutting these helical gears.

### D. Gear Train Geometry

As mentioned previously, geometry calculations for the helical gears came from Avallone et al, and Oberg et al. Such calculations may be utilized to determine the gear's values needed to cut them. TABLE 10 below is included to provide supplemental information for this purpose.

TABLE 10
Gear Train Supplemental Information

| Parameter | Value |
|---|---|
| $Mesh 1 Reduction Ratio ( \frac{{d}_{2}}{{d}_{1}} )$ | 0.643 |
| $Mesh 2 Amplification Ratio ( \frac{{d}_{4}}{{d}_{3}} )$ | 1.313 |
| $Output Mesh Reduction Ratio ( \frac{{d}_{6}}{{d}_{5}} )$ | 4.667 |
| $Shift Ratio ( \frac{{d}_{1}}{{d}_{2}} \frac{{d}_{4}}{{d}_{3}} )$ | 2.042 |
| Total Reduction when Mesh 1 is Engaged | 3 |
| Total Reduction when Mesh 2 is Engaged | 6.125 |
| Center Distance | 1.558 in. |

Note:
dn is Gear #n’s pitch diameter (where n = 1, . . . , 6)

### E. Pressure Angle and Interference

Because audible noise may be an issue in the eMDW, every gear has a helical angle of 30°. With this in mind, EQUATION 2 is used to avoid tooth interference, and AGMA 908-B89 (pg. 30, pg. 35) was used to check that the teeth number selected for the meshes did not need special addendum reconsiderations.

$$N = \frac{2 k}{( 1 + 2 m ) {sin}^{2} θ} ( m + \sqrt{{m}^{2} + ( 1 + 2 m ) {sin}^{2} θ} ) \qquad ( EQUATION 2 )$$

where:
N: Number of teeth in the smaller gear in mesh
k: Tooth depth constant (1 for full-depth teeth, which is what is used here; 0.8 for stub teeth (not used in this project))
θ: Normal Pressure angle

$$m : reduction ratio = \frac{{N}_{Driven Gear}}{{N}_{Drive Gear}}$$

Another interference check that one has to make is done so that the three star gears in Mesh 1 and 2 do not intersect with each other. Because Mesh 1 is an amplification and Mesh 2 a reduction, this only matters in Mesh 2, for the current prototype. The derivation, equation, and diagram for this are found in pages 53 to 55 in the University of Texas Report by Bandaru/Tesar. To use this interference check equation, it should be noted that the addendum diameter is simply calculated from EQUATION 3:

Addendum Diameter: D°=(2*Addendum)+Pitch Diameter (EQUATION 3)

The helical angle of 30° was chosen to reduce noise while gears mesh and to increase the load carrying capacity of the gears. This is the case because in a small face width, the helical teeth have a large surface area of contact, and when a new pair of teeth are coming into contact, they glide into each other with two or more teeth in contact.

### F. Face Widths

After some analysis, it was determined that Mesh 1 and 2 should each have a face width of 0.5 in, and the Output Mesh a face width of 0.85 in. for Gears #5, which are in the Output Mesh, and have their face widths equal to their pitch diameter to reduce the torsional distortion of these gears. With these peak load values, the stresses in each mesh is below the material's allowable stresses (see TABLES 11-12 below).

### G. Gears Stresses and Material

When calculating the stresses on a gear tooth, there are many stress correction factors that can be looked at, but not all of them are needed in every design situation. Because this is a preliminary look at the eMDW prototype, only a few AGMA standard correction factors were used. The correction factors considered, along with an explanation for their consideration, are shown in TABLES 11-12 below.

TABLE 11
Stress Correction Factors Used

| Correction | | | |
|---|---|---|---|
| Factor | Symbol | Value | Explanation |
| Dynamic Factor | Kᵥ | 1.5 for Mesh 1 and 2 | Budynas (p. 750) shows a graph |
| | | 1.1 for Output Mesh | where based on angular velocity and |
| | | | gear quality, these values can be |
| | | | estimated. Gear's angular velocity |
| | | | used here can be found in subsection |
| | | | 3 below, and the gear quality was |
| | | | estimated to be low-medium. The |
| | | | Output Mesh has a lower factor |
| | | | because it is going at a lower speed |
| | | | than Mesh 1 or 2 when engaged. |
| Load | Kₘ | 1.6 | Bandaru/Tesar (p. 30) and Avallone |
| Distribution | | for every gear mesh | et al (Table 8.3.14) have tables |
| Factor | | | where it is stated that for: “Less rigid |
| | | | mountings, more bearing clearance, |
| | | | less accurate gears, contact across |
| | | | full face” the value of 1.6 should be |
| | | | used. Because we are after relatively |
| | | | low cost, while still meeting the |
| | | | eMDW torque demands, this lower |
| | | | level of precision should be |
| | | | acceptable for an initial prototype. |
| Elastic | Cₚ | 2300 psi | This is the elastic coefficient for |
| Coefficient | | for every gear mesh | steel-on-steel gear meshing. This |
| | | | value comes from Avallone et al, pg. |
| | | | 8-97. |
| Geometric factor | J | 0.53 for Mesh 1 | The AGMA Information Sheet |
| for bending | | 0.52 for Mesh 2 | shows that for a 20 degree pressure |
| | | 0.52 for Output Mesh | angle, 0 degree helical angle on |
| Geometric factor | I | 0.167 for Mesh 1 | Mesh 1 and 2, and a 15 degree |
| for pitting | | 0.157 For Mesh 2 | pressure angle on the Output Mesh, |
| | | 0.24 for Output Mesh | these values are the average for the |
| | | | presented prototype gearing. These |
| | | | numbers are also dependent on the |
| | | | number of teeth in each gear. |

More information about these correction factors may be obtained from Bandaru/Tesar (p. 26-38), Chapter 14 of Budynas, the AGMA Information Sheet 908-B89, Avallone et al, and Oberg et al.

With these correction factors and the geometry of the gears already calculated, pages 55 to 60 in Bandaru/Tesar help calculate the Tangential Load, Bending Stress, and Contact Stress at each mesh. First, the tangential load of Output Mesh (fₜ^{OM}) needs to be calculated based on the torque requirement of 250 and 500 lbf-ft. EQUATION 4 is used for each case.

$${f}_{t}^{OM} = \frac{T}{3 {d}_{p}^{R}} ( Bandaru / Tesar , pg \text{.159} ) \qquad ( EQUATION 4 )$$

With this, equations from the Bandaru/Tesar report help in finding the values below. These values are found when the Clutch is engaged with Gear #1 or #3, independently, see TABLE 12 for the results.

TABLE 12
Gear Train Loads and Stresses

| | |
|---|---|
| Parameter | Value (per star gear) |

Gear #1 Engaged (First Gear, High-Speed)

| | |
|---|---|
| Mesh 1 Tangential Load | 351 lbf |
| Output Mesh Tangential Load | 504 lbf |
| Mesh 1 Bending Stress | 46,973 psi |
| Output Mesh Bending Stress* | 28,344 psi |
| Mesh 1 Contact Stress | 109,313 psi |
| Output Mesh Contact Stress* | 131,629 psi |

Gear #3 Engaged (Seconds Gear, Low-Speed)

| | |
|---|---|
| Mesh 2 Tangential Load | 485 lbf |
| Output Mesh Tangential Load | 1,008 lbf |
| Mesh 2 Bending Stress | 53,100 psi |
| Output Mesh Bending Stress* | 56,687 psi |
| Mesh 2 Contact Stress | 241,139 psi |
| Output Mesh Contact Stress* | 186,152 psi |

*×0.8 due to internal helical gear, which has a greater contact surface that external gear teeth

TABLE 12 shows the stress requirements that Mesh 1, 2 and Output Star Gears need to meet independently with different transmission settings. The low-speed configuration is used primarily when designing and choosing material for gears at the output mesh, since it results in a higher bending and contact stress under the 500 lbf-ft of wheel torque than the high-speed configuration. Mesh 1 and 2 should be looked at independently, as load is only carried when their respective clutch face is engaged.

TABLE 13 is included for comparison purposes, to show the allowable stresses for common gear materials, as seen in Budynas' (p. 741, p. 743) and Collins' (p. 634, p. 642). Note that the highest bending and contact stresses seen in Table 14, 56,687 psi for the output mesh during Low-Speed and 186,152 psi are below AGMA Grade 3 by a safety factor of 1.3 and 1.5, respectively.

TABLE 13
Common Steel Gears Allowable Stresses

| | | Allowable | Allowable |
|---|---|---|---|
| AGMA | Heat | Bending Stress | Pitting Stress |
| Grade | Treatment | (Sat) psi | (Sac) psi |
| 1 | Flamed Or | 22,000 | 170,000 |
| | Induction | | |
| | Hardened | | |
| 2 | Flamed Or | 55,000 | 190,000 |
| | Induction | | |
| | Hardened | | |
| 3 | Carburized and | 75,000 | 275,000 |
| | hardened | | |

### H. Overall Gear Design Summary

The first reality is to obtain and tabulate specific numerical results for the resulting gear values. These include the gear's teeth count, the face width, the pitch diameter, the peak load bending and contact stresses (using AGMA load correction factors) and associated safety factors for bending and contact. Safety factors are calculated using AGMA's Grade 3 material, TABLE 13. The values are given in TABLE 14.

TABLE 14
Summary of Gears’ Geometry, Stresses, and Safety Factors

| | | | Pitch | Peak | Peak | | |
|---|---|---|---|---|---|---|---|
| | | Face | Dia- | Bending | Contact | Bending | Contact |
| | Teeth | Width | meter | Stress | Stress | Safety | Safety |
| Gear | Count | (in) | (in) | (psi) | (psi) | Factor | Factor |
| #1 | 28 | 0.5 | 1.897 | 46,973 | 209,313 | 1.6 | 1.3 |
| #2 | 18 | 0.5 | 1.22 | | | | |
| #3 | 16 | 0.5 | 1.348 | 53,100 | 241,139 | 1.4 | 1.1 |
| #4 | 21 | 0.5 | 1.769 | | | | |
| #5 | 15 | 0.85 | 0.85 | 56,687 | 186,152 | 1.3 | 1.5 |
| #6 | 70 | 0.85 | 3.967 | | | | |

Each mesh represents a reduction ratio, tooth contact ratio, all based on the number of teeth, the gear pitch diameter, the pressure angle of 25° and the helical angle of 30°. Each mesh is under distinct loads from either peak value (500 lbf-ft) and continuous operation (200 lbf-ft). This provides the comparative tabulation of TABLE 15 for final analysis.

TABLE 15
Comparative Analysis

| | | | Bending | Bending | Contact | Contact |
|---|---|---|---|---|---|---|
| | | | Safety | Safety | Safety | Safety |
| | | | Factor | Factor | Factor | Factor |
| | Reduction | Contact | for | for | from | for |
| Mesh | Ratio | Ratio | Continuous | Peak | Continuous | Peak |
| 1 | 0.643 | 2.78 | 4.0 | 1.6 | 2.1 | 1.3 |
| 2 | 1.313 | 2.49 | 3.5 | 1.4 | 1.8 | 1.1 |
| Output | 4.667 | 4.22 | 3.3 | 1.3 | 2.3 | 1.5 |

The peak load of 500 lbf-ft occurs when the gear train is in Low-Gear (Mesh 2 and Output) to provide maximum reduction of 6.125 for high acceleration at low speeds. High-Gear occurs with Mesh 1 and Output under a total reduction of 3. Specifically, the safety factors of 1.3 and 1.6 during peak bending and contact stress, respectively, are sufficient because of the low duty cycle of perhaps 1% for peak loads. For continuous operation at 200 lbf-ft, then these safety factors are 3.3 and 1.8 which are very comfortable for the full duty cycle and should enable a long-life durability (say exceeding 20,000 hours or 1 million miles of normal driving conditions). If the safety factors for contact stresses on Mesh 2 (Gear #3 and 4) are considered a bit low, then increasing their face width from 0.5 in. to 0.6 in. results in bending factors (continuous and peak) of 4.2 and 1.68 and contact factors (continuous and peak) of 1.97 and 1.2.

### I. Bearings

The bearing placement is shown in FIG. 1. When finalizing this prototype and readying for build, one should make the effort to calculate stresses, deflections, and other failure modes in the shafts and bearings so that the best judgment can be used when selecting the materials for these elements. Here, a brief effort will be made along these lines.

Due to the symmetry of the star gear configuration, ball bearings 14, 17, 21, 22 and 23 and needle bearings 16 and 19 are subjected to small radial loads and serve mainly for the purpose of alignment. Note that these needle bearings may benefit from having no race and a cage and just rolling on a hardened shaft and gear due to space limitations. Thrust bearings 15 and 20 are in place for axial thrust force of the helical gears. Gears in Mesh 1 and 2 should be angled in the same orientation, and the Output Mesh gears should be aligned in the opposite orientation so that the axial load on the thrust bearings and ball bearings is lessened.

The gear bearing is an important part of the eMDW, due to the fact that it will be carrying load from a stationary structure attached to Part 1 to an output structure. This may need to be fabricated as a custom piece. The seal 51, also shown in FIG. 1, is preferably low friction and serves the purpose of containing lubricant and maintaining the inside of the eMDW free of debris from the external world.

When looking for bearings in a supplier catalog, one of the values that rates a bearing is it rotational velocity. TABLE 16 below states such velocities for the bearings of the eMDW.

TABLE 16
Bearings Max Rotational Velocity

| | Max Rotational | |
|---|---|---|
| Bearing Number | Velocity (RPM) | Clutch State |
| 14, 21 | 3,000 | Any |
| 15, 16 | 1,469 | Second Gear |
| 17, 22, 23 | 4,667 | First Gear |
| 19, 20 | 2,125 | First Gear |
| Gear Bearing | 1,000 | First Gear |

As mentioned in the Introduction, both at low and high-speed settings, the motor will be running at a max of about 3,000 RPM. Using this fact and the ratios from TABLE 10, the values above were calculated. Bearings 14 and 21 support the drive shaft, and because the motor that will be used should function at maximum of around 3,000 RPM, so should these bearings. Bearing 15 and 16 are related in that Gear #1 drives both of them, and bearings 19 and 20 are both driven by Gear #3. Bearings 17, 22, and 23 have the same RPM because they are press fitted onto the star shaft and therefore will always move in unison.

The highest RPM for bearing pairs (15, 16) and (19, 20) happens when they are free-wheeling (i.e. its mesh is not engaged), which is expected because when its mesh is engaged, the gear moves at a zero-velocity relative to the Drive Shaft. Overall, these are modest values, and bearings are readily available that are rated for these velocities at the dimensions described in the separate but available Design Prototype of eMDW document, Bearings List section. After final selections of bearings is done, the bearing support dimensions of the eMDW should be updated before it is machined.

### J. Shafts

To get an idea of the material required for the shafts in this prototype, torsional deflection and shear stress is calculated. Assuming that the bearings are frictionless and that the only load acting on the Stars Shaft is due to the torque caused by the gears meshing, the following equation can be used to find torsional angle of twist deflection of the shaft (in radians):

$$θ = \frac{Tl}{GJ} ( Budynas , p ℊ \text{.115} ) \qquad ( EQUATION 5 )$$

where torque is:

T=fₜr_{G} (EQUATION 6)

and the polar 2^{nd} moment of area is:

$$J = \frac{π {d}^{4}}{32} ( Budynas , p ℊ \text{.115} ) \qquad ( EQUATION 7 )$$

In these equations, l is the length of the shaft (from, and including, Gear #2 to Gear #4), G is the modulus of rigidity (which depends on material), fₜ is the tangential load (found in TABLE 12 above), r_{G} is the pitch radius of the gear rigidly attached to the shaft (either Gear #2 to Gear #4), and dis the diameter of the shaft. If one is willing to accept a twist deflection of 0.0095 radians (0.5 degrees), TABLE 17 shows the modulus of rigidity needed in the shaft material.

TABLE 17
Modulus of Rigidity needed for Star Shaft based of Clutch State

| Clutch State, Gear Engagement | Modulus of Rigidity (G) Needed |
|---|---|
| High Speed, Gear #1 | 6.8 × 10⁶ psi |
| Low Speed, Gear #3 | 9.8 × 10⁶ psi |

TABLE 17 shows that the highest modulus (and therefore the one the shaft material needs to have) is 9.8×10⁶ psi, when Gear #3 is engaged. “Modulus of Rigidity” shows that cold rolled steel has a modulus of 10.9×10⁶ psi. This gives a safety factor of 1.1. The safety factor may be increased to 1.5 if the radius of the shaft is increased to 0.65 in, from the current 0.6 in.

The largest shear stress that will be experienced by the shaft can be found using EQUATION 8:

$${τ}_{max} = \frac{Tr}{J} ( Budynas , p ℊ \text{.115} ) \qquad ( EQUATION 8 )$$

where T is found with Eq. 6 using values from Table 4, J with Eq. 7, and r is the radius of the Star Shaft. The max shear stress in the Star Shaft comes out to be 7,955 psi, when Gear #3 is engaged (Low-Speed) which is very low. This number should be taken into account when choosing the shaft's material.

This disclosure, along with Design Prototype of eMDW, are a strong starting design for a prototype of this eMDW. However, there are some actions that need to be resolved before the actual construction of the eMDW starts.

First, the bearings need to be selected from a bearing catalog. Section 3 of Design Prototype of eMDW, Tabulation of Bearings, lists the current dimensions of all the bearings, their top rotational speed, and the dimensions that should not be altered much to maintain structural integrity within various parts.

Second, clearance between moving parts needs to be established. For example, clearance between any of the rotating gears and the Back Walls needs to be given, as well as in the sliding clutch spline.

Third, bolts and bolt threads need to be defined throughout the system. These may be off-the-shelf items, like the bearings.

Fourth, a low-friction seal for the bearing-gear needs to be selected. Fifth, a hand-clutch system needs to be added to the current working drawings to allow manual transmission between Low and High Gear for an early prototype.

Lastly, a tolerance stack-up analysis needs to be performed, after clearance has been set, bearings selected, bolts selected and hand clutch added. The importance of this is so that parts fit and perform properly.

Future iterations of this eMDW, possibly including the first prototype, should make an effort to install a sensor base within the actuator, a hub for which can be found in the cavity created by the Internal Wall Cage (Part 3). This hub could also support the actuating solenoid being considered for future design iterations for the clutch. Also, a strong effort needs to be made to reduce the weight of the eMDW by considering different materials, other than steel, in parts where low loads are experienced, or webbing some solid surfaces (i.e., light weighting).

IX. eMDW Prototype Drawings/Descriptions

### A. Introduction

This disclosure presents the machining drawings for a prototype of a two-speed eMDW. It is broken down into two main parts: first, listing containing important design details about every part and bearings of the eMDW, and second, the actual working drawings of the eMDW. For information about the design/engineering decisions, please review the Description of Design document.

### B. List of Parts

The components of a preferred embodiment of the MDW disclosed herein are set forth in TABLE 18.

TABLE 18
MDW Components
Name: Strong Back Wall and Outer Shell

| | | |
|---|---|---|
| Part #: 1 | Quantity: 1 | Machining Drawing Sheets 21-24 |

Description:
Has two (precision surfaces) insets for assembly purposes: one for the Internal Cage
Wall (Part 3) and another, with a precision boss, for the Stationary Principal Bearing
Outer Race (Part 12).
The outer surface cutout in the Shell part of this is meant to reduce weight; further weight
reducing improvements should be pursued in this and other parts.
The top disk part of this, where the Ø0.4 in. bolt cavity is located, is where the weight
of the vehicle will travel down to the wheel. The support that this section provides due
to its thickness and ruggedness is very important. And, the Ø0.4 in. bolts should
withstand lateral axial shock in the wheel drive.
Gears #1 through 4 and the clutch system are enclosed by the Shell section and Part 2.
The three Ø1.2 in. cavities of the Strong Back Wall hold the outer race of bearing 22
which supports the Star Shafts (Part 4).
Name: Back Wall

| | | |
|---|---|---|
| Part #: 2 | Quantity: 1 | Machining Drawing Sheets 25-28 |

Description:
Enclosing back part of the eMDW shell, attaches onto Part 1.
Its three Ø2.3 in. cavities hold the outer race of bearing 17 which supports the Star Shafts.
The central Ø1.6 in. cavity holds the outer race of bearing 14 which supports the Driving
Shaft (Part 5). This cavity also holds thrust bearing 15.
Name: Internal Cage Wall

| | | |
|---|---|---|
| Part #: 3 | Quantity: 1 | Machining Drawing Sheets 29-32 |

Description:
Attaches to Strong Back Wall (Part 1), using carefully placed precision surfaces.
Its unique geometry is meant to offer rigid structure where needed and reduce weight
where not. The three sections, one of which is marked as DETAIL B in Machining
Drawings Sheet 4, hold the outer race of bearing 23 which supports the Star Shaft. This
is where rigid structure is needed. Next to them, however, material has been taken off.
Name: Reduction/Amplification Gears (Star) Shaft and Gear #5

| | | |
|---|---|---|
| Part #: 4 | Quantity: 3 | Machining Drawing Sheets |

Description:
Gear #5 is part of this star shaft. Note that the pitch diameter and face width of this gear
are the same to reduce torsional distortion.
This gear has an involute profile, with a helical angle of 30° and normal pressure angle
of 25°. Further details about this gear, which are needed to cut it, are included in
Drawings Sheet 5 below.
This shaft is held in place by bearing 17, 22 and 23, and each of those is mounted in Part
2, 1 and 3, respectively.
The square key cavities follow ANSI B17.1 guidelines; square keys are recommended
for shafts of this diameter.
In the Description of Design document, section 4 has details about loading and deflection
of this shaft.
Name: Driving Gears and Clutch Shaft

| | | |
|---|---|---|
| Part #: 5 | Quantity: 1 | Machining Drawing Sheets |

Description:
Gear #1 and #3 are attached to this central shaft via needle bearings 16 and 19, which
allows them to rotate freely when the clutch is not engaged.
This shaft is supported by Part 1 and 2 via ball bearings 14 and 21, and thrust
beatings 15 and 20.
The prime mover connects to this driving shaft via an internal spline at one
end of the shaft.
The Clutch Ring (Part 6) slides on the external spline in the middle of this shaft.
Name: Clutch Engagement Ring

| | | |
|---|---|---|
| Part #: 6 | Quantity: 1 | Machining Drawing Sheets |

Description:
Part of the clutch system, used to engage with either Gear #1 or #3 to provide low and
high-speed transmission.
The inner splines slide on Part 5.
When finalizing this prototype, the clearance between the inner spline and Part 5 needs
to be carefully considered to ease the sliding motions. To also ease this motion, this
material may have a fine hardened finish.
Each face of the ring has tapered dog leg insets to allow for smooth engagement with
their respective gears.
The rest of the clutch system is currently not specified, but for a first prototype, an
external pivoted hand clutch should be enough for testing purposes.
Name: Gear #1

| | | |
|---|---|---|
| Part #: 7 | Quantity: 1 | Machining Drawing Sheets |

Description:
This pinion gear has an involute profile, with a helical angle of 30° and normal pressure
angle of 25°. Further details about this gear, which are needed to cut it, are
included in Drawings Sheet 8.
This is one of the driving gears, and it is fitted to the Driving Shaft (Part 5) with
needle bearing 16.
High-Speed transmission is achieved when this gear is engaged to clutch (Part 6)
Thrust bearing 15 supports Gear #1 axially.
Name: Gear #2

| | | |
|---|---|---|
| Part #: 8 | Quantity: 3 | Machining Drawing Sheets |

Description:
This star gear has an involute profile, with a helical angle of 30° and normal pressure
angle of 25°. Further details about this gear, which are needed to cut it, are included in
Drawings Sheet 9 below.
These gears are also referred to as Star gears, as they are rigidly attached to the Star Shaft
(Part 4) via square keys.
These gears transmit power only during High-Speed operation.
Name: Gear #3

| | | |
|---|---|---|
| Part #: 9 | Quantity: 1 | Machining Drawing Sheets |

Description:
This pinion gear has an involute profile, with a helical angle of 30° and normal pressure
angle of 25°. Further details about this gear, which are needed to cut it, are included in
Drawings Sheet 10.
This is another of the driving gears fitted into the Driving Shaft (Part 4)
via needle bearing 19.
When the dog leg is engaged to Clutch Ring (Part 6), Low-Speed
Transmission is achieved.
Thrust bearing 20 supports Gear #3 axially.
Name: Gear #4

| | | |
|---|---|---|
| Part#: 10 | Quantity: 3 | Machining Drawing Sheets |

Description:
This star gear has an involute profile, with a helical angle of 30° and normal pressure
angle of 25°. Further details about this gear, which are needed to cut it, are included in
Drawings Sheet 11.
Like Gear #2, these gears are also referred to as Star gears, as they are rigidly attached
to the Star Shaft (Part 4) via square keys.
These gears transmit power only during Low-Speed operation.
Name: Output Gear #6 with Bearing Inner Race

| | | |
|---|---|---|
| Part #: 11 | Quantity: 1 | Machining Drawing Sheets |

Description:
This principal internal gear has an involute profile, with a helical angle of 30° and normal
pressure angle of 25°. Further details about this gear, which are needed to cut it, are
included in Drawings Sheet 12.
This part belongs to the principal gear-bearing assembly, it contains the internal gear
with 70 teeth and the inner race of the four-point ball bearing.
The vehicle's weight travels down this piece, from the bearing race to the Output
Connection which is right next to it. The rigidity of this solid piece, as well as the large
Ø0.4 in. Output Connection bolts are meant to withstand the weight and shock that may
occur during operation.
Name: Stationary Principal Bearing Outer Race

| | | |
|---|---|---|
| Part #: 12 | Quantity: 1 | Machining Drawing Sheets |

Description:
This piece is the outer race of the principal bearing, combined with the inner race
(Part 11).
This part carries the vehicle's weight from bolt cavities to the bearing race 12.
Name: Output Gear Cover Plate

| | | |
|---|---|---|
| Part #: 13 | Quantity: 1 | Machining Drawing Sheets |

Description:
This thin piece of material serves the purpose of enclosing the eMDW by
attaching to output link Part 11.
The seal between the disk and the outer race 12 then tightly closes the unit.

TABLE 19
Tabulation of Bearings

| Part | | Current Dimensions | |
|---|---|---|---|
| # | Quantity | (in.) | Description |
| 14 | 1 | Outside Diameter: | Ball bearing |
| | | 1.6 | Fits into Back Wall (Part 2) to support Driving Shaft |
| | | Inside Diameter: 1 | (Part 5) |
| | | Width: 0.3 | Mainly for alignment purposes as the three Star shafts |
| | | | offset the load felt by the Driving Shaft |
| | | | This could also be a roller or needle bearing, as thrust |
| | | | bearing 15 will carry the axial load caused by the |
| | | | helical gears; although a ball bearing could provide |
| | | | some support |
| | | | It is critical that when looking at bearing catalogs, that |
| | | | one stays as closely as possible to these dimensions. |
| | | | Most importantly, the inside diameter should not be |
| | | | reduced as it would take material away from the |
| | | | Driving Shaft where it connects to the prime mover. |
| | | | Also, one should be aware that increasing the outer |
| | | | diameter would bring this bearing near bearing 17. |
| | | | Aside from interfering with each other, this may not |
| | | | be an issue as these bearings only meet in three points |
| | | | in what is otherwise a continuous plate structure (i.e. |
| | | | the Back Wall). |
| | | | Its width should not be increased, as space needs to be |
| | | | left for the thrust bearing 15. |
| | | | A max RPM of about 3,000 is expected |
| 15 | 1 | Outside Diameter: | Thrust bearing |
| | | 1.6 | Fits into Back Wall (Part 2) to support Gear #1 against |
| | | Inside Diameter: 1 | axial load due to the helical angle of the gears. This |
| | | Width: 0.1 | load should be lessened if the helical angle of the |
| | | | Output Mesh is configured in the opposite direction |
| | | | Like bearing 14, one should be careful when altering |
| | | | the outside and inside diameters. |
| | | | A max RPM of about 1,469 is expected |
| 16 | 1 | Outside Diameter: | Needle bearing |
| | | 1.6 | Fits into Driving Shaft and supports Gear #1 |
| | | Inside Diameter: | This bearing supports no axial loading, that is taken |
| | | 1.18 | care of by bearing 15. And, it has low radial loads. |
| | | Width: 0.5 | When looking at bearing catalogs, one should try to |
| | | | not reduce the inside diameter, as to not take away |
| | | | material from the Driving Shaft. |
| | | | The outside diameter should not be increased by much |
| | | | either, to maintain material in Gear #1. |
| | | | One may consider bearings with no race, i.e. rolling |
| | | | on hardened surfaces in Gear #1 and Driving Shaft |
| | | | A max RPM of about 1,469 is expected |
| 17 | 3 | Outside Diameter: | Ball bearing |
| | | 1.2 | Fits into Back Wall to support Star Shafts |
| | | Inside Diameter: 0.6 | When looking at bearing catalogs, the inner diameter |
| | | Width: 0.4 | should not be reduced much, if any, to maintain |
| | | | structural integrity in the Star Shafts |
| | | | A max RPM of about 4,667 is expected |
| 19 | 1 | Outside Diameter: | Needle bearing |
| | | 0.65 | Fits into Driving Shaft and supports Gear #3 |
| | | Inside Diameter: 0.4 | This bearing supports no axial loading, that is taken |
| | | Width: 0.5 | care of by bearing 20. And, it has low radial loads. |
| | | | When looking at bearing catalogs, one should try to |
| | | | not reduce the inside diameter, as to not take away |
| | | | material from the Driving Shaft. |
| | | | The outside diameter should not be increased by much |
| | | | either, to maintain material in Gear #3. |
| | | | One may consider bearings with no race, i.e. rolling |
| | | | on hardened surfaces in Gear #3 and Driving Shaft |
| | | | A max RPM of about 2,125 is expected |
| 20 | 1 | Outside Diameter: | Thrust bearing |
| | | 1.026 | Fits into Strong Back Wall (Part 1) to support axial |
| | | Inside Diameter: 0.4 | loads on Gear #3 due to helical angles |
| | | Width: .15 | Like bearing 21, one should be careful when altering |
| | | | the inside diameter |
| | | | A max RPM of about 2,125 is expected |
| 21 | 1 | Outside Diameter: | Ball bearing |
| | | 1.026 | Fits into Strong Back Wall to support Driving Shaft |
| | | Inside Diameter: 0.4 | Like bearing 14, it is mainly for alignment purposes |
| | | Width: .35 | This could also be a roller or needle bearing, as thrust |
| | | | bearing 20 will carry the axial load caused by the |
| | | | helical gears; although a ball bearing could provide |
| | | | some support |
| | | | When looking at bearing catalogs, the inside diameter |
| | | | should not be reduced to maintain the structure of the |
| | | | Driving Shaft |
| | | | Its width should be maintained to allow for space for |
| | | | thrust bearings 20 |
| | | | A max RPM of about 3,000 is expected |
| 22 | 3 | Outside Diameter: | Ball bearing |
| | | 1.2 | It has the same function as bearing 17 |
| | | Inside Diameter: 0.6 | Fits into Strong Back Wall to support Star Shafts |
| | | Width: 0.5 | When looking at bearing catalogs, the inner diameter |
| | | | should not be reduced much, if any, to maintain |
| | | | structural integrity in the Star Shafts |
| | | | A max RPM of about 4,667 is expected |
| 23 | 3 | Outside Diameter: | Ball bearing |
| | | 0.8 | Fits into Internal Cage Wall (Part 3) to support |
| | | Inside Diameter: 0.4 | Driving Shaft |
| | | Width: 0.25 | When looking at bearing catalogs, one should try to |
| | | | stay as closely as possible to the current dimensions |
| | | | so that minimal material is removed from the Star |
| | | | Shaft or Internal Cage where these bearings are being |
| | | | supported |
| | | | A max RPM of about 4,667 is expected |

X. Benefits of Star Compound Vs. Epicyclic Gear Trains for Power Transmissions

### A. Overview

The lowest possible cost for transmissions required for ubiquitous but economically important actuators will utilize standard components, readily available manufacturing methods, and rapid assembly techniques to enable mass production in minimum sets. The benefits of the one plane star compound (SC) gear train versus the epicyclic (EP) used in 99% of the better actuators, suggests that the star compound will enable a revolution in cost-effective actuators of ever-increasing performance-to-cost. The rough estimates obtained here indicate a factored benefit of the SC over the PE is 23× for lower-end applications and 413× for upper-end (demanding) applications (that is, the benefit is 18× higher for the more technically dense actuators).

### B. Background

The star compound (SC) and the Epicyclic (EP) appear visually the same. Both have a central axis with a front-end sun gear. Both have multiple gears symmetrically arranged about the central axis. Both use helical gearing to carry higher loads (more than one tooth in contact). Both use needle bearings to conserve volume (lower diameter gear pitch circles). The reverted SC has the same central small diameter output shaft as the EP does. Both can profit by using compound gears to increase reduction ratios. It is unfortunate that these visual similarities mask the dramatic benefits of the SC over the EP, as will be shown by a careful listing of relative benefits.

C. Tabulated Benefits of the SC over the EP

TABLE 20 presents ten distinct (and likely independent benefits) of the unheralded star compound actuator transmission over the widely used epicyclic transmission. This comparative listing will include the 2-speed versions of each transmission (utilizing a clutch to switch between two speed ratio reductions). Each benefit will be given as a benefit ratio of the SC relative to the EP for Low End (LE) applications and those that must meet High End demanding requirements (RE).

The star compound has fixed star gears on shafts whose bearings are stationary in fixed strong back walls. Each star shaft ends with a star gear to drive an internal gear with a reduction of 5 up to 7-to-1. This last reduction is unusually stiff benefiting from its large diameter internal gear and adjacent large diameter gear bearing to create a shortest force path configuration. Given a normal first reduction of 4 to 5-to-1, the total reduction can be 20 up to 35-to-1 (not using compound gears). The simple epicyclic has all its planet gears held on needle bearings (the gears are a little larger in diameter) to mesh with an internal gear in the transmission's shell. The high inertia rotating cage (with rotating gears and shafts) then drives the slender output shaft through a small diameter bearing (which reduces stiffness). The reduction between the sun and cage is relatively small (3-to-1) to keep the planets sufficiently small. This can be increased to 9-to-1 by using compound gearing in the planets and a smaller ring gear. Generally, larger reduction ratios are achieved by using multiple EPs in series.

In this benefits review, the case is considered where both the SC and the EP offer 2 speeds. For the SC, this means using a small diameter splined dog-leg clutch on the drive shaft to alternatively drive two parallel SC sun/star gear sets which, then, drives the single mesh of output star gears (on the same star shafts) with the large diameter internal output gear. For the EP, this means having two separate sun/planets meshed with a splined ring gear that can mesh with each of the sun/planet planes. In some cases, the ring gear meshes with each set of planets to lock up the whole as a rigid cage or the ring gear only meshes with one of the planet gear sets to provide two distinct reduction ratios of 3-to-1 up to 9-to-1.

TABLE 20
Listing of Benefits (SC-Compound, EP-Epicyclic)

| | | Low | High |
|---|---|---|---|
| Criteria | Description | End | End |
| Reduction Ratio | The SC can offer much higher reduction ratios | 3 | 4 |
| | (SC up to 35-to-1) vs. the EP (up to 9-to-1) | | |
| Inertia | The EP carries a high burden of inertia of a heavy | 1.5 | 3 |
| | rotating cage; all gears in both translation and | | |
| | rotation. Further, all planet gears experience | | |
| | centrifugal forces to put loads on their fragile | | |
| | needle bearings. By contrast, the SC has only | | |
| | rotating star gears in larger protective low velocity | | |
| | bearings in the stationary strong back walls. | | |
| Striffness | The EP carries its cage on central low stiffness | 2.0 | 4.0 |
| | bearings. The output of the EP is my means of low | | |
| | diameter output shaft. By contrast, the SC has all | | |
| | bearings in rigid/stationary strong back walls, has | | |
| | star gears on rigid star shafts driving a large diameter | | |
| | internal gear using a gear bearing in a shortest force | | |
| | path to provide exceptional stiffness. | | |
| Machine Joint | Increasingly, actuators must not only drive a | 1.5 | 3.0 |
| | machine joint, they must also act as the machine | | |
| | joint. This, then, enables plug-and-play of highly | | |
| | coupled and nonlinear machine systems (actuators | | |
| | frequently in a demanding force fight). The SC uses | | |
| | a shortest force path through the gear bearing | | |
| | between the frame of the neighboring link and the | | |
| | output to the next link to dramatically improve | | |
| | system stiffness and resistance to shock while the EP | | |
| | offers only a small diameter and low stiffness (in all | | |
| | directions) output shaft. | | |
| Number of Parts | The SC has an extra plane of output gears relative to | 0.9 | 0.7 |
| | the EP. The one plane SC has the same number of | | |
| | gears as the EP. The unique gear bearing does add | | |
| | some cost. | | |
| Accuracy | Backlash is a primary indicator of accuracy and, | 1 | 1 |
| | therefore, potential cost. Both the one plane SC and | | |
| | EP have the same number of meshes, so, it is | | |
| | expected that their accuracies would be similar. | | |
| Clutches | Both the SC and EP require one clutch to provide | 1.2 | 1.5 |
| | two distinct speed ratios. The SC can use the proven, | | |
| | very compact and rapid dog-leg clutch (given quality | | |
| | sensors to ensure mesh synchronization). | | |
| | Unfortunately, the EP depends on a large diameter | | |
| | splined ring gear with a large diameter of “dogs” in | | |
| | the mesh to add inertia in the clutch motion and | | |
| | requires more time to close. | | |
| Weight & | The SC has an additional plane of gears which adds | 1.2 | 1.5 |
| Volume | to the module's weight and volume although the EP | | |
| | has the extra weight of the cage. Effectively using | | |
| | the SC's webbed strong back walls attached to its | | |
| | shell should enhance stiffness allowing lower | | |
| | structural weight. Also, the shortest force path | | |
| | enhances this overall stiffness. | | |
| Helical Gears | The helical gears in the SC can be used to create | 1.1 | 1.3 |
| | canceling bearing thrust forces while no similar | | |
| | choices exist in the EP. This, then, reduces bearing | | |
| | wear and some reduction in bearing size. | | |
| Gear Size | Because the star gears for the SC are rigidly fixed to | 1.2 | 1.4 |
| | their shafts, they can be smaller in diameter. The EP | | |
| | must use needle bearings to increase the diameters | | |
| | of the planets. Also, the large last plane reduction | | |
| | ratio of the SC drops the mesh forces and torques in | | |
| | the up-front star gears, therefore, reducing their size | | |
| | (diameter) substantially reducing the shell diameter | | |
| | which means reduced weight and volume in the | | |
| | front-end of the SC relative to the EP. | | |

| | | |
|---|---|---|
| Overall Factored Benefit | 23 | 413 |

### XII. Advanced Development of Low Complexity/Low Cost Actuators Based on the Star Compound Gear Train

### A. Objective

The systems and devices disclosed herein may be utilized to further simplify the design for production of a large spectrum of low-cost/low-complexity gear trains to be integrated in a wide spectrum of electro-mechanical systems (intelligent actuators) used by a large portion of the population (vehicles, robots, exoskeletons, mobility platforms, construction/farm machinery, handling/packaging, etc.). This result is based on the exceptional (and unheralded) star compound gear train composed of very simple components which can be produced in minimum sets in large quantity to substantially reduce cost and enable systems to be rapidly assembled, repaired, and refreshed on demand.

### B. Background

Gear train based actuators are commonly used to drive machine systems to produce products and to respond to command to meet human needs. Over the past few decades, simple offset gearing (two parallel axes) has been replaced with an axially symmetric epicyclic gear train (with perhaps 3 to 5 planet sets rotating about the central axis in a rigid cage). This combination of a cage and planets represents considerable inertia and adds about 25% to the gear count (less stiffness, more cost). The star compound gear train also has a similar symmetry about the central axis, but all the “star” gears rotate about fixed bearings in fixed strong back walls, which reduces the number of bearings, increases stiffness, reduces inertia, and reduces cost.

TABLE 20 (above) outlines a comparative benefits analysis of these two basic gear reducers in terms of 10 measures. These measures are considered to be largely independent, enabling their factored combination (benefit multiplication) with an overall high end benefit of 413× for the star compound relative to the epicyclic. The systems, devices and methodologies disclosed herein may be utilized to accelerate the development of fully integrated intelligent actuators to fill a wide range of human needs at lower cost (and higher performance).

As previously noted, the star compound gear train is especially suitable for use in low complexity actuators. There, it was shown that a simple 2-plane set of gears (pinion plus star gears (plane 1) driving a set of star gears to drive the output gear bearing (plane 2).

One of the major attributes of the star compound gear train is the use of a large diameter small cross-section principal bearing (a 4 point bearing, a cross roller bearing or a grooved roller bearing) between the shell attachment and the output attachment plane. This large diameter gear bearing provides exceptional ruggedness (load capacity, stiffness, shock resistance, etc.) for loads in all directions in what is termed the shortest force path. This means that no additional bearing structure is necessary to drive the load (for example, a joint in a robot manipulator, a wheel on a car, or a large ship propeller). This last feature is not feasible for an epicyclic gear train, which further eliminates it from extensive utilization in future electro-mechanical systems.

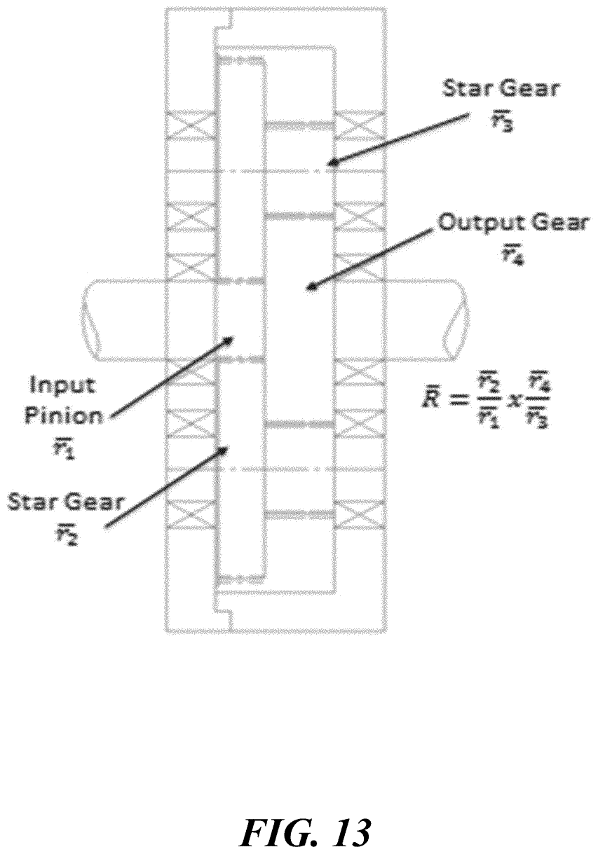

The gear reducer may be expanded to include a simple front end inverted star compound (see FIG. 13) between the prime mover and the principal rugged output star compound. This inverted reducer expands the reduction ratio by 10× or more, which may be needed in some high torque density applications using a higher rpm (low weight) prime mover with a very rugged high torque final gear reduction stage.

The basic star compound gear train may also be utilized to create a revolutionary power-dense electric drive wheel. In fact, this gear train is essentially a pair of single plane front end pinions (separated by a clutch) which drive star gears that, in turn, drive a large diameter internal gear supported by the principal gear bearing. Each of the two pinions in these two gear planes free wheel on needle bearings until they are connected to the prime mover shaft with a sliding (on a spline) dog leg clutch. Hence, the system can be either in neutral (the clutch is not connected to either of these pinions) or it may connect with the larger diameter pinion (on the left for a total of a 3-to-1 ratio) or to the smaller pinion (on the right for a total of 6-to-1 ratio). The 3-to-1 results in high gear and the 6-to-1 results in low gear. As an example, using a 20 h.p. motor at each wheel (80 h.p. for 4 wheels on a small car) results in an estimated motor and gear train total weight of 40 lb. This has merit because it reduces un-sprung weight, enables plug-and-play, and substantially reduces cost of EVs (Electric Vehicles) of the future. Hence, the star compound is central to this principal application, meeting a human need with reduced life cycle cost (perhaps 50%), and points the way to a very broad range of electro-mechanical system applications.

### C. Overall Description

It is desirable for a gear train to minimize cost while satisfying a maximum range of applications. Preferred embodiments of the gear reducer disclosed herein allow a high RPM smaller motor (high air gap velocity/low force level) to deliver significant power through a gear reducer to transfer that power (at 99% efficiency) to a lower-speed, higher-torque output.

For example, for electric drive wheels, the reduction of 3-to-1 in high gear and the 3000 RPM motor speed becomes 1000 RPM at the wheel or 70 mph. The need for higher torque at lower speeds is universal in most applications. For example, packaging food containers in boxes rarely requires speeds above 1 cycle per second (60 RPM). In such applications, a reduction of 100 up to 200-to-1 might be warranted so that the motor may run at 6000 up to 12000 RPM. Hence, the reducer gives the system designer necessary choices to meet a given application's requirements and still keep cost at a minimum.

To manage these costs, it is desirable to build a large population of actuators (motor, gear train, sensors, controllers, etc.) from a minimum set of components made available from a competitive supply chain. For example, today a versatile supply network enables computer board designers to select from a minimum set of electronic components (chips, board networks, switches, connectors, etc.) to virtually create a board on demand with practiced expectation that the result will meet the application requirements. This certainly was not the case before 1970, when there existed electronic tubes, wiring bundles, complex switching systems, cooling systems, and multiple voltage adjustments.

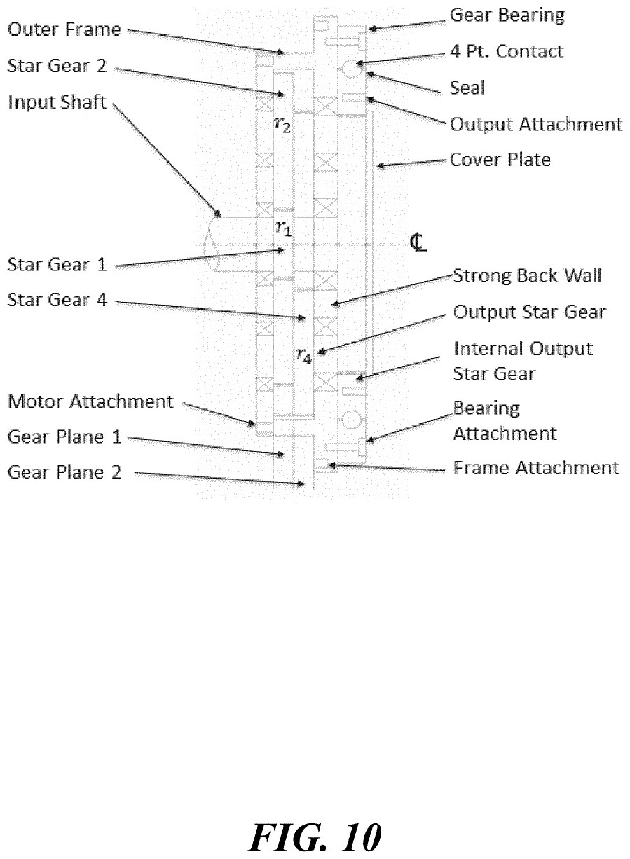

This essential success does not yet exist for electro-mechanical actuators. The motor/controller is increasingly being made in this paradigm, but not the gear reducer. FIG. 10 depicts a particular, non-limiting embodiment of this envisioned “modular” component constructed reducer. The reducer depicted therein is a pancake reducer intended for high torque and exceptional ruggedness. The input shaft (from the prime mover or an upfront reducer stage) drives a pinion (r₁) which drives a star gear (r₂), which is rigidly connected to an amplifier gear (r₃) to drive an output star gear (r₄) which is tied together on the same star shaft to an external gear (r₅) which finally drives an internal gear (r₆) to provide the necessary output torque for the application. Note that r₆ is part of the previously mentioned gear bearing. These six gears combine to give the reduction ratio given by EQUATION 9:

$$R = \frac{{r}_{2}}{{r}_{1}} \times \frac{{r}_{3}}{{r}_{4}} \times \frac{{r}_{6}}{{r}_{5}} \qquad ( EQUATION 9 )$$

It immediately becomes clear that this represents an enormous number of choices (∞⁶). Further, all gear teeth (spur and helical) require choices on parameters such as the number of teeth, pressure angle, tooth height and backlash (which also must be designed for load capacity, stiffness, durability, etc.). Hence, the number of choices quickly reaches ∞²⁰
(or 20 independent parameters). This range of choices is presently too high a burden for the average application engineer. Hence, the specialist still designs the reducer for a specialty house which then, charges a premium for the one-off design that might satisfy the application (to some degree), which represents a weakness in the supply network.

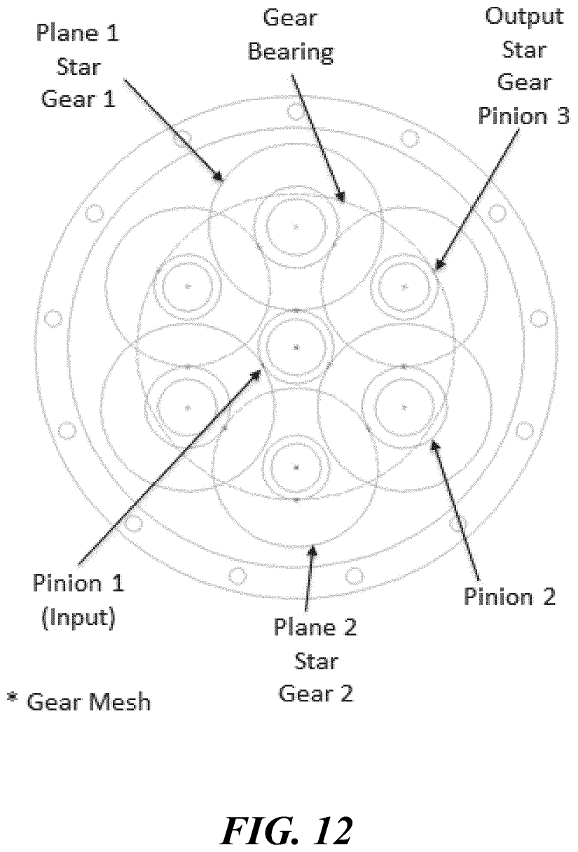

With reference to FIGS. 10-14, there are a finite number of components in the reducer. These are:

Input Pinion (r₁)

Compound Star Gear (r₂, r₃)

Output Dual Star Gears r₅)

The Principal Gear Bearing (r₆)

The Strong Back Wall

The Reducer Shell

The Reducer Back Plate

Numerous Internal Bearings

It is desirable to standardize each of these components in minimum sets as building blocks for the reducer. The result must represent a very large range of reduction ratios, pancake or coffee-can shapes, overall size (scale of torque), and other considerations.

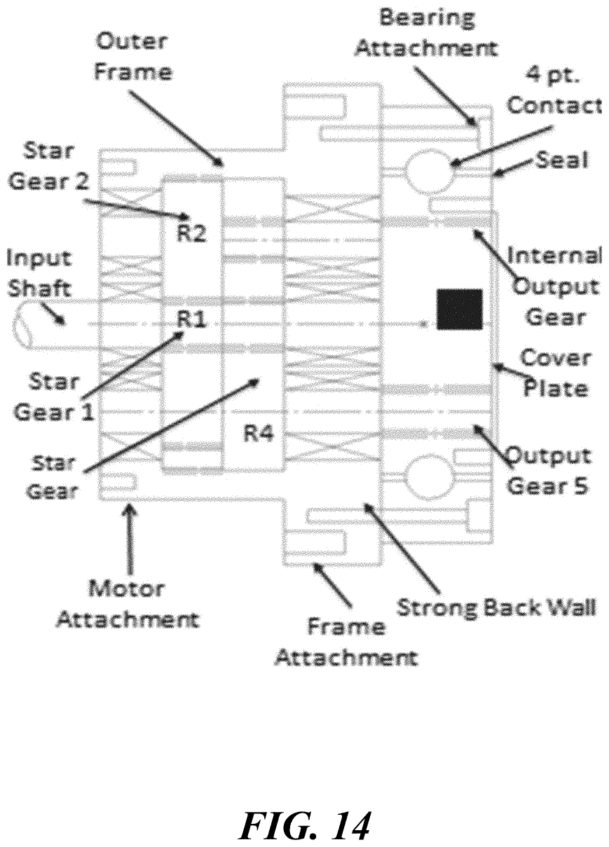

FIG. 14 displays a coffee-can shape for the basic reducer along with a special inverted star compound reducer as a potential front end of a two stage reducer to produce reductions above 40 to 1.

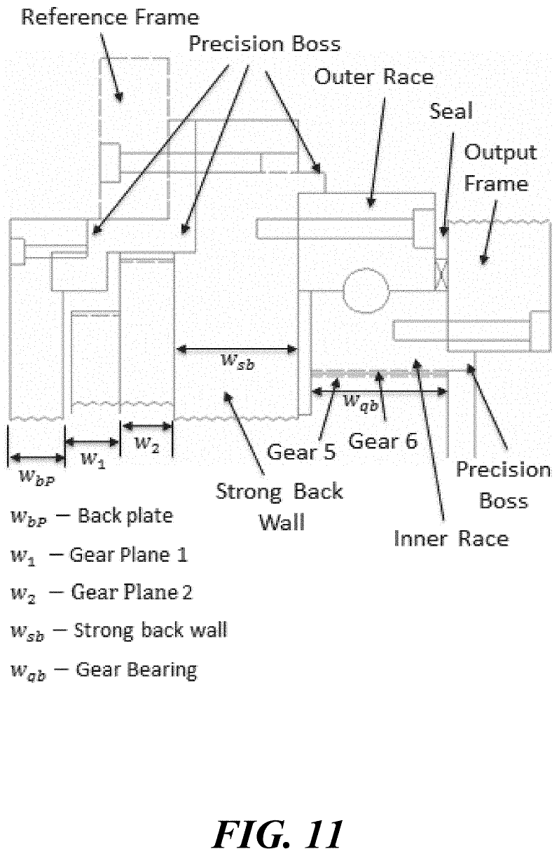

FIG. 11 shows the internal assembly of gears for the back end pancake and coffee can reducers. It also shows detailed geometry to assemble the basic components of the output structure of the final stage of the reducer. The gear bearing r₆ is driven by star gear r₅. Gear r₆ is structurally part of the principal gear bearing which provides a bolt attachment to the output frame (centered by a precision boss as used on car axle/wheels). The outer race of the gear bearing is attached (with bolts) to the strong back wall and also centered with a precision boss on the strong back wall. Finally, the shell provides a bolt attachment for the reducer through a cylindrical shell centered with a third precision boss. These three precision bosses enable the rapid and accurate assembly of the standard components which make up the reducer which will now be described in more detail. Each component, summarized in TABLE 21 below, becomes a mass-produced item in minimum sets to reduce cost.

TABLE 21
Standard Components

| Component | Description |
|---|---|
| Input Pinion (r₁) | This pinion would be integral to the central shaft of the prime |
| | mover or a front end inverted SC). Here, r₁ drives r₂ with a ratio |
| | of 2.0, 2.5, or 3.0. |
| Compound Star | This star gear contains two gears rigidly attached to each other on |
| Gear (r₂, r₃) | the same star shaft where r₃ < r₂ by a factor of 2.0, 2.5, 3.0. |
| The Output Gear | This gear r₄ is driven by r₃ on a separate star shaft. |
| (r₄, r₅) | Here, r₄ and r₅ are rigidly attached to the same output star shaft. |
| | Note that r₄is larger than r₃by 2.0, 2.5, or 3.0 |
| Principal Gear | This critical component combines the output gear r₆ with the |
| Bearing (r₆) | principal output bearing of the unit (either a 4 pt. or cross roller), |
| | is unusually rugged, stiff, and resists shock and forces from all |
| | directions, while still being relatively small and low weight. |
| Strong Back Wall | Now, this becomes the rugged backbone of the reducer, which |
| | holds the bearings for the central and star gear shafts. It may be as |
| | wide (and solid) as the gear bearing. The force from the reference |
| | frame to the output frame travels through the strong back wall |
| | through the gear bearing to the output in what is called here the |
| | shortest force path (maximum stiffness for minimum weight). |
| | Because of the precision bosses, it can now be treated as a |
| | standard component to be produced in minimum sets. |
| Reducer Shell | This shell is necessary to close off the reducer connecting the |
| | strong back wall to the back plate using two precision bosses (one |
| | at each end), bolted together during assembly. |
| Reducer Back Plate | This back plate is used to support bearings on the central shaft |
| | and the star gear shafts in concert with the strong back wall [symbol] |
| | complete the total structure of the reducer. |
| Numerous Internal | In addition to the gear bearing, there are a total of 14 bearings to [symbol] |
| Bearings | support the one central shaft and 6 star shafts. Using helical gea [symbol] |
| | requires these bearings to be opposed tapered roller bearings |
| | resist the axial thrust created by the helical teeth. If possible, the [symbol] |
| | 14 bearings will all be the same size and fitted in press fit sockets. |

[symbol]

indicates data missing or illegible when filed

### D. Minimizing the Number of Standard Components

The initial set of pancake or coffee can reducers may have external shell diameters of 4″, 5″, 7″, 10″, 15″, 20″, which will enable load capacities with torques from 1000 to 50,000 ft-lb. The coffee can may range from 4″ to 15″, while the pancake may range from 5″ to 20″. This begins the minimum set in that the coffee can will be almost as long as it is in diameter, while the pancake would be 3× larger in diameter relative to its axial length. This means that the coffee can is more power dense (at higher output velocity), while the pancake is more torque dense (at lower output velocity).

The various component width ratios will be closely associated with force levels in the gear meshes, which are closely related to the mesh ratios. It is expected that the gear bearing width w_{gb} will be equal to that of the strong back wall w_{sb}. The front planes of gears (either a single plane r₁, r₂, or two planes including r₃, r₄) will then have a total width of w_{f}=w₁+w₂ where w₁ represents r₁, r₂, and w₂ represents r₃, r₄ (i.e., w_{f}=w_{sb}=w_{gb}). It is then expected that the back plate will have a thickness w_{bp} at 50% of the strong back wall or w_{bp}=0.5w_{sb}. Finally, it is expected that w₁=0.4w_{f} and w₂=0.6w_{f} to proportion the width of the two planes of gears (see FIG. 11).

Each gear mesh will have a reduction ratio of g (simply 2.0, 2.5, 3.0). These ratios are called force magnifications (gains) here labeled as g. In these principal star gears, the force gain will be a constant. Also, for simplification (to create more standard gearing to reduce cost), the pinion gear r₁ will be the same diameter and tooth number as output gear r₅. All of these ratios (design constraints) reduce choice complexity without reducing the usefulness of the reducer to a wide range of applications.

The basic reducer contains gears r₁, r₂ up to r₆. Here,

r₂=gr₁

r₃=r₁

r₄=gr₃=gr₁

r₅=r₁

r₆=r₁(2+g)

Hence, all the mesh ratios are set by the choice of g and the total reduction ratio becomes:

R₂=(2+g)g² (EQUATION 10)

which dramatically reduces the choice complexity for the designer. If the amplifiers (r₃, r₄) are removed to make a single plane principal gear set, then:

R₁=(2+g)g (EQUATION 11)

Now, introducing a front end inverted star compound reducer to drive this back end reducer, we use gears r̅₁, r̅₂, r̅₃, r̅₄ to designate the principal gears. Here, the reduction ratio becomes:

$${R}_{i} = \frac{{\overline{r}}_{2}}{{\overline{r}}_{1}} \times \frac{{\overline{r}}_{3}}{{\overline{r}}_{4}} = {g}^{2} \qquad ( EQUATION 12 )$$

### E. Actual Feasible Reduction Ratios (R)

FIG. 10 tabulates the range of total reduction ratios now feasible. In each case, only three values are used for the force gain g in the gear meshes, which are:

g=2.0,2.5,3.0

i.e., this represents only three values that need to be chosen to obtain a very large set of reduction ratios. For the single plane SC of gears r₁, r₂, these are:

R₁=8,11.25,15

For the two plane SC back end reducer, these are:

R₂=16,28.125,45

which is a very useful range for most basic applications with a cost-effective reducer. Driving the back end SC (having reductions R₁ and R₂) with the inverted SC front end with reduction R₁, yields overall reduction ratios of:

\tilde{R}₁=R₁×Rᵢ, \tilde{R}₂=R₂×Rᵢ (EQUATION 13)

Here, the ratio \tilde{R}₁ ranges from 72 up to 240-to-1 while \tilde{R}₂ ranges from 144 up to 720-to-1.

It is to be noted that, for all these ratio values, only 3 values have to be chosen for g. Although some basic choices must be made (for example, for a one or two-plane reducer or one with a front end reducer, or the basic output shell diameters), the number of choices is very direct and easily understood. Doing so enables the mass production of the minimum sets of the 8 components that make up these reducers, which thus poses the question of how large these minimum sets are.

### F. Minimum Component Sets

Each choice of the size or diameter of the shell fixes all the diameters of the gears, shafts and bearings, which are all proportional to this choice. For each class of reducer (pancake, coffee can), the widths of all the components may be standardized as proportional to the width W (W=D for coffee can and W=⅓ D for the pancake) relative to the shell diameter D. Hence, virtually all dimensions depend on two simple choices: the shell diameter D and the gear force gains g. Nonetheless, a range of torques is provided from 1000 to 50,000 ft.-lb., and a range of reduction ratios is provided from 8-to-1 up to 720-to-1 (see FIG. 10).

The use of the up-front inverted SC (reduction Rᵢ) is recommended only for a few special cases where very low output speeds (and high output torque) are desired. This leaves the choice of parameters D, g to govern the design choices for the standard SC for most applications with total reduction ratio ranging from 8 to 45-to-1. Further, the tooth parameters (for example, the number of teeth, tooth weight, pressure angle, and surface treatment) are largely governed by the class of gears (normally from class 5 to 12). With helical gears, angles vary from 10° to 30°. The larger the angle, the more teeth in contact (2 or 3), with larger load capacity and quieter operation. Some of these parameters have only 3 values. Some may require more refinement (depending on cost, durability, stiffness, etc.). Nonetheless, this reduced set of choices enables standardization (as currently exists for electronic components), which enables production in minimum sets to be supplied by a competitive supply chain. Each standard component may now be certified in-depth, upgraded with minimal disturbance to the producer or user, and fully documented for contractual purposes.

### XIII. Application of Multi-Speed Drive Wheels (MDW) to Heavy Transport Systems

### A. Objective

The multi-speed wheel drives (MDW) disclosed herein may be utilized to enhance the performance of heavy transport vehicles as found in passenger trains, diesel electric freight locomotives, and in ore mine operations. The benefits include lower weight (up to 50%), higher efficiency (up from 75% to 87%), plug-and-play repair (standardized modules), more rapid speed attainment (up to 40% less time to 35 mph), and reduced lifecycle cost (from 25 to 50%).

### B. Background

Heavy transport generally utilizes either external power supply (power cables or rails) or internal battery power (which is somewhat less effective). This class of power thus requires electric wheel drives, which have slowly moved from brushed DC to brushless DC and now almost universally to AC synchronous. Sometimes, these drives depend on sophisticated electronic converters to best respond to changing operating conditions (such as, for example, speed, torque, and temperature), which is especially necessary in stop-and-go trolleys, hill-climbing transport, or in poor weather.

Most of these drivelines are attached to the axles of dual rail wheels where the motor is offset (in parallel) from the axle using very simple one-speed gear reducers attached to the axle (frequently called nose support). This allows more vertical space for a larger diameter drive motor (the requirement is that the motor must have 2.5″ clearance above the rails). A two-truck locomotive may use two 2,144 h.p. motors (one on each truck). Some drives have motor center lines perpendicular to the axles (parallel with the rails) which, then, requires bevel gears that are very inefficient (up to 3% friction losses).

The gear reducer is frequently a pinion (driven by the motor) which drives a 3× larger gear attached to the axle. In subway cars, the reduction can be up to 7.235-to-1 with a 22 inch diameter motor to conserve space. In Europe, one motor frequently drives two axles on a single truck. In most systems, the wheels will be outside of these drives (inside the truck frame) where the truck frame supports the car/locomotive on springs (both coil and air). In most cases, the available space for the driveline is considered small, which limits design flexibility. In trolley or passenger trains, driveline noise must be as low as possible. In mine rail transport, height is an issue which results in 31″ wheels, 4 pole box frame motors, and narrow tracks (42 to 48″) to require forced air ventilation with due regard for dirt filtering to obtain clean air for cooling.

In general, the U.S. train components use higher speed AC motors with somewhat smaller wheels (not in freight systems). Diesel electric locomotives generally provide 4000 to 6000 h.p. (GE has been the only U.S. producer). Most heavy transport systems rely on very effective traction based on wheel/surface adhesion. At low speeds, this adhesion depends on the torque that can be maintained (T=L×R×μ, is contact force, R is wheel radius, and μ is surface friction coefficient). These are designed for maximum adhesion (minimum wheel/rail slip). In general, they use automated stator field control to achieve high 0.4 to 0.45 adhesion.

GE also is the primary provider of Off-Highway Trucks (OHV) with 1800 up to 2700 h.p. for open pit ore mines. These all use motors with constant torque up to their base rotor RPM speed (usually 50% of maximum speed) and then constant power beyond that to full speed. In general, the passenger cars provide accelerations of 0.1 to 0.14 g, while freight trains (of 10 to 20 mil. lb.) operate at very low accelerations of 0.0015 to 0.0035 g (i.e., 20 to 40× less).

### C. Representative European Drivelines

A few drivelines are currently available in Europe. Those available from Gmeinder Getribe are listed in TABLE 22.

TABLE 22
Gmeinder Getribe Drivelines

| Label | | | | |
|---|---|---|---|---|
| (Shaft | | | | |
| Diameter) | Speed (mph) | Ratio | RPM | Torque (ft-lb) |
| Tramway | 42 | 7.28 | 4000 | 610 |
| (6.4) | | | | |
| Switch Eng. | — | 5.95 | 3064 | 4500 |
| (9.6) | | | | |
| 180 HA | 84 | 3.31 | 3000 | 4500 |
| (7.2) | | | | |
| 200 EV | 120 | 3.68 | 3200 | 6000 |
| (8.0) | | | | |
| 190 EHA | 120 | 3.8 | 2070 | 9183 |
| (7.6) | | | | |

Those available from D.B. Santasalo are listed in TABLE 23.

TABLE 23
D.B. Santasalo Drivelines

| | | | |
|---|---|---|---|
| 16 ton | 80 | 5.4 | 6500 |
| 16 ton | 60 | 6.8 | 7000 |
| 16 ton | 85 | 5.5 | 9900 |
| 19.8 ton | 80 | 7.07 | 10600 |

Generally, most drive wheels are 5″ wide and 44″ in diameter. The total width of the locomotive is 106″ wide with 53.5″ between the wheels for the driveline. This leaves up to 19″ from the inside of the wheels to the outside of the vehicle.

### D. Issues and Requirements

In general, locomotive drive technology development has concentrated on the electrical tech base with only nominal efforts (virtually none) concentrating on mechanical gearing (multi-speed) and issues of maximum efficiency, responsiveness, and minimum life cycle cost using intelligent decision making for enhanced operation in response to operational needs. The primary concern has been on the torque production of the prime movers and how they must be controlled to minimize slip (complete loss of control in traction efficiency, and response to command). Added to these concerns is the small space/volume (frame square with minimum height) in which to put rather large motor/gear modules. In this case, AC motors are necessarily round (while DC motors can have a more square cross-section) with a larger diameter (which can be modified using 4 and 6-pole systems, which also decreases end turn length).

A general measure is the Speed Ratio Power. Pᵣ indicates the power actually used relative to that which was available from the power source. This is not loss of energy, but represents non-use of available power (i.e., it means batteries have to be larger due to low Pᵣ values). Power factor values range from a low of 0.6 to a high of 0.9 and sometimes 0.95, which is highly desirable. Generally, Pᵣ increases in large motors operating at full power. A related measure for real-time control is the speed ratio power (Pₛᵣ=Pᵣ ωₘᵣ/ω_{c}) where ωₘᵣ is the maximum speed possible for a given load relative to its rated power, while ω_{c} is the actual motor speed. Also, AC motors have higher Pᵣ values than DC motors (64% more Pᵣ, 43% better Pᵣ density).

Generally, AC motors are easier to cool than DC motors. In particular, without temperature-driven corrective control, a DC motor at low speed and high load can burn up in minutes. AC motors (and recent DC motors) use no commutator brushes, which reduces the need for maintenance. ACs can generate more power (higher power density). Basic freight locomotive motors provide 4400 h.p. at 600 volts and 5500 amps with gear reduction ratios from 2.85 up to 4.1-to-1. Recent development has resulted in the PMAC (permanent magnet AC), which produces twice the horsepower at higher speeds; i.e., they weigh ½ as much with ½ the volume. In general, BLDCs are best as smaller motors, especially since they are quite expensive.

Special issues occur for 4 and 6-wheel trucks. As the locomotive accelerates, the front wheels have 20% (or more) less contact load. With interlocked gearing/inverter control, all wheels necessarily must operate at 20% less driving torque. This means that individual wheel control (torque and slip) would reduce the needed peak power by 20%. This is also true of peak braking torque (either through negative wheel torque or mechanical brakes).

### E. Open Pit Ore Mine Transport Requirements

Pit mines have a very demanding ore removal cycle. These off-highway vehicles have an electric driveline produced by GE. The lifting grade is at 10% (equivalent to 12% due to friction in the mechanical drive components) with a 20 to 45 min. roundtrip cycle. The total vehicle weight (with 150 ton payload) is 850,000 lb., which means that the driving force is 0.12×850,000=102,000 lb. with a speed of 6 to 7 mph. This driveline uses a high quality two-reduction/one-speed star compound gear train.

### F. Proposed Use of Two-Speed MDW

Unfortunately, the driveline of most heavy traction locomotives uses refined prime mover designs and control with virtually no attention for a refined and productive gear reduction system. Gear reducers are essential to create high output torque while increasing motor speeds (with reduced overall weight). Otherwise, motor speeds would be too low to result in very low efficiencies. The real problem is that with one fixed gear ratio, the wheel torque is completely dependent on the motor torque capability, which diminishes rapidly at higher rotor speeds. This means that acceleration up to 35 mph is, on average, approximately 40% less than if two-speed ratios would be available. This means that for the same size of motor, maximum lower speeds could be reached in 40% less time.

Actuators based on a 2-speed star compound gear reducer with an internal clutch to change the speed ratios (say, 3-to-1 and 6-to-1) exceed most commercial practice by 3 to 4 orders of magnitude. The multi-speed drive wheels (MDWs) described herein are useful for all scales of vehicles, especially electric hybrid vehicles or full battery powered vehicles. The MDW is unusually power dense, providing a peak torque of 500 ft-lb. in a weight of less than 50 lb. In general, the MDW's high continuous torque/power density exceeds any simple solutions now commercially available. Using 10 measures, the overall factored performance benefit is more than 400×. Its inertia content is exceptionally low to enable rapid command response. Its driveline stiffness is high (helical gear teeth) with an exceptional output principal gear bearing (either a 4 pt. ball, a cross roller, or a grooved roller bearing). This bearing means that the actuator is also the machine joint. In vehicles, it is the wheel bearing with exceptional stiffness (at a low weight penalty) in all directions. All of these features make a special drive system possible for heavy traction vehicles.

Other criteria may be utilized to assess the value of the MDW for heavy traction vehicles. The MDW has the necessary torque density to provide high acceleration with very low weight. Because of its exceptional simplicity, it is expected to be highly durable (say, 20,000 hours and 1,000,000 miles of travel). It is also necessarily shock resistant to maintain this durability. Extensive analysis of multiple vehicle duty cycles shows that average efficiency (because of the choice of two speeds) goes from 75% for one speed to 87% for two speeds. Low inertia content also means low weight and high acceleration. Using modern embedded criteria-based decision making may provide maximum acceleration, efficiency, temperature management, reduced time-to-speed levels, and other advantages. Overall, the MDW two-speed gear reducer provides an excellent tech base in balance with the proven AC synchronous motor.

### G. Utilization of the MDW for Heavy Traction Vehicles

For fleet vehicles, buses, trucks, construction machinery, and other such applications, it is recommended that all fully-electric vehicles use an MDW to drive each traction wheel. For the bus and fleet vehicles, this might mean two separate plug-in MDWs for the rear axle. Given two axles, four MDWs can be used. Recently, hydrogen fuel cell power generation has been shown to be increasingly feasible to charge a battery package with exceptional simplicity (modularity). For trucks with two power axles, four MDWs can be used (with two smaller MDWs on one of the axles of the towed trailer). All of these systems use 2, 4, or 6 MDWs, all independently controlled, to provide exceptional torque vectoring for maneuverability for safety (especially in poor weather). Further, to climb a hill, all MDWs can operate at peak power (which means overall driveline weight goes down). Going downhill, all MDWs may regenerate power to reduce brake demand. Running on ideal flat surfaces at constant speed, perhaps only 1 or 2 out of 6 MDWs (or 1 out of 4 MDWs at low speeds) may be used to drive the vehicle at maximum efficiency while reducing the wear on the unutilized MDWs.

### H. Locomotive Traction Drives

Normally, train/trolley trucks are either 4 or 6 wheeled with 2 trucks per locomotive. Hence, there are 8 to 12 wheels that are driven with 2 to 4 motors. Most of these are interlocked to provide modest independent control (for enhanced adhesion, efficiency, acceleration, and other purposes). Here, a separate MDW module is recommended for each wheel, which maximizes reconfiguration to match acceleration, traction, efficiency, durability needs with no single point failures. This means that one failed (or weakened) MDW may be taken out of service (say, 1 out of 12) with only an 8% traction penalty. This means that twelve 360 h.p. MDWs would result in a total power level of 4320 h.p. Another advantage of these twelve MDWs is that their smaller modular structure enables mass production at lower cost to enable highly certified modules provided from a competitive supply chain.

This raises the interesting question of mounting the MDW on the truck frame. One advantage of doing so is to enable rapid change-out of a weakened (failed) MDW and even low cost refreshment (replaces enhanced MDWs with those that have improved over the lifetime of the locomotive). Note that present locomotives have remained relatively unchanged over several decades. This may be best achieved by placing the MDW on the outside of the truck frame. This approach may then dispense with the wheel axles using a rigid reinforced double ladder frame. Doing so would mean that the MDW must provide the wheel bearing as well, integral to its exceptional mechanical design.

The wheel may have an enlarged bolt circle to match a larger MDW output plate (say, 20″ in diameter). The MDW body would preferably be 15″ to 18″ long along its centerline to fit easily within the available 21.5″ external space under the locomotive body. It is expected that the MDW would average 1000 lb. in weight for a total of 12,000 lb., which is expected to reduce overall truck weight by 6,000 lb. Given an 800,000 lb. locomotive, this would represent a low 3% of the total weight. Each truck would preferably employ a combination of mechanical coil and air springs.

It now becomes very useful to analytically estimate the acceleration, speed/time benefits of having two distinct speed ratios in the MDW. Preferred embodiments of the 360 h.p. MDW will preferably operate in low speed (6-to-1 ratio) up to 35 mph (51 ft./sec.). The wheel in such an embodiment may reach 270 RPM with the motor at 1635 RPM. Output torque is 7000 ft-lb. (with an input torque of 1167 ft-lb.). Because of constant torque up to 1635 RPM, the acceleration is constant.

For a 10 mil. lb. train, the acceleration would be a₁=0.0046 g (for 20 mil. lb., a₁ would be 0.0023 g). Note that the total acceleration force would be 45,826 lb. for 44″ wheels. Then, the Δt₁=5.74 min. to 35 mph. From 35 to 70 mph, the speed change is also 51 ft/sec. Because the gear ratio in high is now 3 to 1, the motor max. speed is 1635 RPM where the motor torque averages 1167 ft-lb. with an output torque of 3500 ft-lb. and a total driving force of 22,913 lb. For a 10 mil. lb. train, a₂=0.0023 g (for 20 mil. lb., a₂=0.00115 g) with an elapsed time of Δt₂=11.48 min. The total time to 70 mph would be Δt=17.22 min. For a one-speed 360 h.p. drive and a 3-to-1 gear ratio, Δt₁=11.48 min and Δt₂₃₂ 15.31 min., for a total of 26.8 min to 70 mph. This thus represents 64% more time to reach full speed. All of this is feasible for the MDW by ensuring that the constant torque of the motor exists up to base speed of the motor.

### General Comments/Recommendations

Generally, using two-speed MDWs for heavy vehicles improves efficiency (more than 12%) and acceleration (up to 40% to 35 mph), reduces driveline weight, improves reconfigurability, eliminates single point failures, reduces cost (due to mass production), and enhances durability (estimated to be 20,000 hours and 1,000,000 miles). Simplicity and minimum parts also reduce cost. Improved traction becomes possible even in poor weather. Because of higher efficiency, battery costs may be reduced. Quick plug-and-play makes rapid repair (even in the field) possible. Intelligent control enables predictive estimates on weakened performance to best manage this repair. Since the MDW is located on the outside of the locomotive truck, it may be handled by a dexterous lift truck (and therefore easily replaced). Once grasped, all bolt circle bolts may be loosened and removed to free up the MDW. There will then be sufficient clearance to also remove the wheel with the lift system without lifting the truck frame.

One of the key components in the MDW is the principal bearing in the shortest force path between the wheel and the truck frame, which dramatically enhances stiffness, reduces weight (by up to 30%), and provides very high shock resistance. Another is the great simplicity of the servo motor driven dog leg clutch to change the speeds in the MDW. All of the above features of the MDW tech base now warrants serious consideration for utilization in all heavy vehicles (as mentioned earlier), especially for more-electrification of those vehicles.

### XIV. A Revolution in Open Architecture Hybrid Electric Vehicles

### A. Objective

Hybrid Electric Vehicles (HEV) have already proven to be energy efficient in city and highway duty cycles while also reducing emissions particularly in urban use. The architecture of this proven HEV concept may be dramatically opened up with a Modular Hybrid Drive (MHD) by creating a distributed transmission providing up to 200 system configurations (multiple 2-speed drive wheels, 2-speed differential drive, a clutched 2 speed I.C. engine running in its efficiency sweet spot), making possible a 2× reduction in cost and a 2× improvement in fuel efficiency.

### B. Background

The most successful hybrid system to-date is the HSD (Hybrid Synergy Drive) by Toyota, which is widely used in 15 Toyota cars (and licensed to many others). The HSD uses a centralized transmission (electric drive-MG2-combined with a clutched ICE through a two input, one output epicyclic gear train) which, then, goes through a differential through universal jointed axles to standard passive wheels. The engine carries a motor generator (MG1) to supply power to charge the battery. This system contains a finite number of configuration choices 4) to respond to duty cycle demands. These configuration choices result in a smaller (lighter) MG1, MG2, ICE and enable the ICE to operate near its efficiency sweet spot.

C. Remarkable 2-Speed Electric Drive Wheel (eMDW)

It now appears that a very rugged low-cost, 2-speed electric wheel drive (eMDW) of exceptional performance and durability is feasible in 40 lb. (and 20 h.p.) and 70 lb. (and 40 h.p.) configurations, which are sufficiently light weight to not require active (and expensive) suspensions for light to medium weight commercial vehicles. This distributed transmission minimizes weight and complexity in the rest of the vehicle while placing the power as close as possible (minimum inertia) to the required active wheel traction force. By contrast, an alternate all-electric wheel drive is available at much higher weight, high cost, low output torque, and very small air gap unprotected against shock by a small axle bearing. The power density of the eMDW described here exceeds the pure electric by 3×, provides a reduced cost of 4×, an exceptional ruggedness better by 5×, and an efficiency 2× better because of operation at all times in its efficiency sweet spot (either electrically or mechanically).

The critical component in the MDW is the 2-speed gear train of very low cost, low weight, exceptional durability, minimum inertia content, low cost bearings, and a unique nano-clutch to enable 10 m·sec. gear shifts of exceptional reliability.

The first principle embodied in this gear train is that all components must be balanced and concentric with the central axis (centerline) so that it generates no destructive out-of-plane moments to demand high structural integrity, larger bearings, larger weight/volume, or other such provisions. Mechanical engineers faced with these design objectives almost invariably turn to the epicyclic gear train which meets all of these goals.

Unfortunately, the epicyclic gear train uses planet gears held in a rotating cage of very high weight, inertia, and large centrifugal forces on the planet bearings. The planets mesh with a fixed shell internal gear to return the torque to a small diameter gear tied to the output shaft. This leads to high gear tooth contact forces, high deformation, high sliding friction, more backlash, potential for wear, and other problems. Moreover, there is no useful location for an essential clutch for speed ratio changes. In other words, the epicyclic is an extremely poor choice for in-wheel eMDWs.

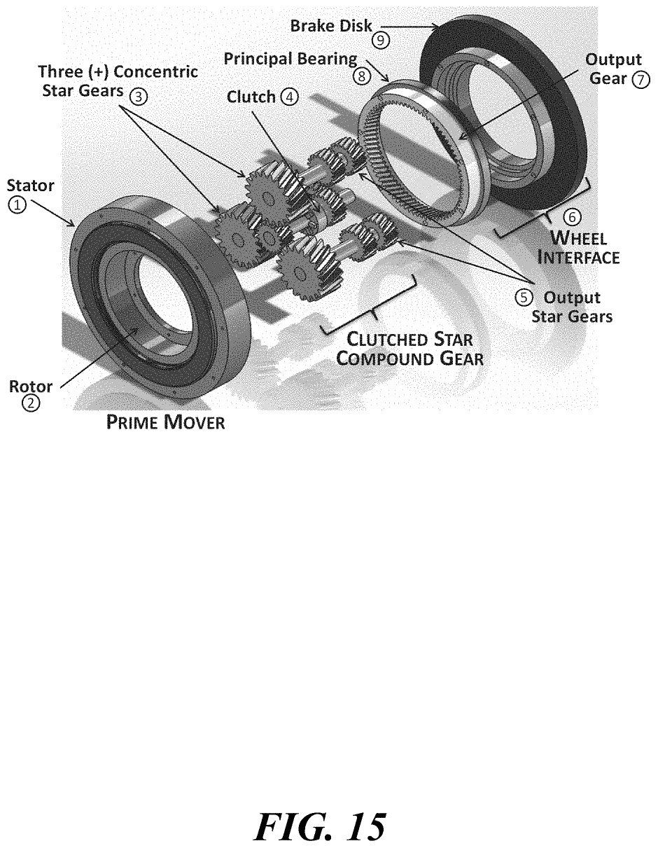

A much better solution is the star compound gear train disclosed herein and shown in exploded view in FIG. 15. At first glance, the star compound gear train bears a strong resemblance to an epicyclic gear train. However, in the star compound gear train, all the star gears (that look like planet gears) have fixed axes in small diameter low velocity bearings which experience very low radial loads. All star gear bearings are supported in strongback walls (as disks to rigidly support the drive's cylindrical walls). These strongback walls make the drive exceptionally rugged and resistant to shock. All forces are concentric about the central shaft. All inertia content is much lower than the epicyclic gear train (perhaps 5×), which permits high responsiveness to command. In other words, this eMDW is ideal to modernize/create distributed transmissions for all land vehicles.

It is important to note that all gears, bearings, shafts, and other components of the star compound gear train are standard components that can be mass produced at low cost. The shell/strongback walls protect the eMDW from shocks from all directions. The BLDC stator reinforces this ruggedness. The clutch is exceptionally small, durable, and responsive in 10 m-sec. The BLDC may stay in its sweet spot for maximum efficiency because of flexible configuration management (hundreds of distinct configurations) at the system level. Overall, the star compound gear train represents a very high performance/cost ratio, in part because it can be mass produced in minimum sets (say, 16, 20, 24, 30, and 40 h.p.).

### D. Customer Component Choices and Utilization

Because of the full plug-and-play modularity, the customer may choose all modules at the time of purchase (which may then be assembled, repaired, and refreshed on demand). Further, the vehicle architect has full freedom to distribute the battery throughout the vehicle to lower the center of gravity and best distribute weight to each of the 4 tires. Also, 2 eMDWs (electric Multi-speed Drive Wheels) may be used at the rear to augment traction at all 4 wheels with virtually no additional architectural complexity (these can always be added later at the customer's choice). Of course, energy recovery is entirely feasible for light braking.

It is recommended that electric brakes be used throughout to most rapidly respond to command in emergency stopping. In hill climbing, all power sources may be required. To maximize highway cruise efficiency, the engine may drive the differential/axles/wheels purely mechanically. In stop-and-go city driving, only 2 electrically driven eMDWs may suffice (with zero emissions) or in very slow traffic, perhaps only the differential eMDW could be used to maximize efficiency and reduce wear on the other drive subsystems. It is to be noted that all of these choices eliminate all single point failures such that the MEM always remains operational at an acceptable level of performance.

### XV. Positive MDW Actuator Performance Measures

In-depth design of the six classes of advanced actuators may be achieved using 25(+) design rules based on a finite number of target performance objectives. These objectives will be discussed briefly here (as Pros) for the tech base to put it into perspective relative to the development barriers (as Cons) still to be met as listed in the next section. Some of these positive objectives are descried further below.

### A. Torque/Force Density

Torque/Force Density is a critical design objective for all actuators. It represents the maximum output torque (or force) that can be produced in terms of minimum weight and volume (Note that power density is a related measure, such that P=Tout×ωout. If P is a constant, then Tout is the inverse of ωout. The shortest force path through the principal bearing contributes to this objective for all actuators in the Tesar tech base. The unheralded star compound excels over the widely used epicyclic by two orders of magnitude. This is especially important for multi-speed drive wheels. The later parallel eccentrics (especially the SPE) provide exceptional torque density (up to 10× the best commercial practice). This is forecast to be 400 ft-lb/lb. after significant further development. Advanced development of linear actuators may provide 750 lb/lb.

### B. Durability

Durability relates to overall life cycle duration and maintenance cost. The star compound excels because of its low velocity bearings in fixed strong back walls, symmetric star gears resulting in no radial loads on the central drive shaft, and simple nano dog leg clutches in the multi-speed versions. In the later parallel eccentrics, no rolling element bearings are in the load path reducing potential bearing failure to almost zero. The circular arc gears provide up to 6 teeth under load with superior bending and contact force stiffness while requiring almost no sliding velocity when carrying their maximum force.

### C. Ruggedness Against Shock

Ruggedness against shock is critical in many applications (such as, for example, construction machines, vehicles, and shop tools). Preferred embodiments of the actuators disclosed herein utilize a large diameter principal bearing in a shortest force path structure to provide superior resistance to external shock in all 6 directions. The star compound excels because of its centerline symmetry of all forces, all star bearings in fixed strong-back walls, and a cylindrical shell tying all the walls together in a very rigid structure. The parallel eccentrics benefit from no rolling element bearings in the load path, extraordinarily stiff/rigid circular arc gear meshes and tongue/groove linear constraint bearings.

### D. Lost Motion and Backlash

Lost motion and backlash are common and necessary in most gear reducers. Star compound gears may exhibit the normal backlash (≈1 arc min). However, due to axial structural symmetry, they do not result in significant lost motion.

Many existing commercial actuators use cycloidal/pin meshes which exhibit very high lost motion when the load is at its highest in magnitude. This also results in low stiffness. The later parallel eccentrics with linear tongue/groove bearings results in virtually no lost motion, exceptional stiffness, and no backlash.

### E. Efficiency

Efficiency is related to sliding friction primarily at the gear mesh and in the bearings. The star compound uses low velocity bearings (and, therefore, low friction forces) and standard involute gear teeth (with a friction loss of 0.5 to 1% in each mesh) to have an overall efficiency of 97% or better. In the parallel eccentrics the gear mesh represents almost no sliding under load so it is almost 100% efficient. On the other hand, the linear tongue/groove constraint bearings must oscillate in short strokes (≈0.25″) at the operating speed (say, 1000 CPM) and may cause friction losses of 5% or more when under high load unless provided with pressurized lubrication.

### F. Responsiveness

Responsiveness can be a critical measure of success in many actuator applications. This requires very torque-dense prime movers (high voltage and current) to provide high acceleration to drive the gear train, typically at minimum rotor inertia. The gear train must have very small effective inertia and exceptional stiffness to make the total effective natural frequency as high as possible (ωₙ=>∞). Relatively, the star compound provides a ωₙ 3 to 5 times higher than the epicyclic (normally used in most actuators). Preferred embodiments of the parallel eccentric (the SPE) excels in that its ωₙ is 10 to 20× higher than existing higher end commercial actuators.

Most hydraulic actuators have a response time of 300(+) msec. Standard high quality commercial electric actuators provide 200(+) msec. response. The SPE should get us to 100 msec. in its first embodiment. Excellent parametric design and electronic control should result in 30 msec. Exceptional development may ultimately reach the target goal of 10 msec. (for example, with a prime mover acceleration of 20,000 rad/sect and exceptionally high natural frequencies).

### G. Intelligence

Intelligence represents the level of internal decision making for the actuator. This begins with a full collection of data generating sensors (10) such as voltage, current, torque, vibration, temperature, etc. Then, each actuator design must undergo extensive metrology to acquire all necessary performance maps (combinations of speed, torque, acceleration, efficiency, temperature, friction, etc.) that are effectively structured look-up tables. These maps then permit extremely fast “decisions” to best respond to commands and deliver control parameter values to operate the actuator. Intelligence then ranks and prioritizes the maps, commands, and responses in a cyclic manner for a superior/fast command response.

### H. Simplicity

Simplicity suggests using the minimum parts in the most symmetric geometry possible. This minimizes the number of distinct part shapes (usually gears), reduces complexity of manufacture, reduces the potential for wear, eases assembly, and improves controllability (response to command). The star compound gear train moves in that direction, especially for multi-speed actuators (drive wheels, wind turbines, VTOL transmissions, etc.). The later generations of parallel eccentrics (especially the SPE) is remarkable in that it has only three gears, two constraint disks, two output plates a two-lobe crankshaft with two supporting bearings, and two output principal bearings in its shortest force path structure. This enables cost-effective manufacture, ease of assembly, and minimum spares for repair, should it be necessary.

### I. Cost

Cost, then, becomes the final criteria on the selection of actuators for a given application domain (such as, for example, aircraft, vehicles, orthotics, and construction machines). For each domain, it is recommended to design and produce in standardized minimum sets (say, 5 for each domain). Each standard actuator can be tested in depth (metrology), it can be evaluated in response to command, durability, efficiency, etc., etc. This then permits certification which then enables the creation of a competitive and responsive supply chain for that domain. Doing so means that performance will go up and cost will go down; i.e., the equivalent of Moore's law for the mechanical field.

### XVI. Utilization of Four-Speed Transmissions

### A. Objective

The goal is to develop the most compact, rugged and lowest cost 4-speed transmission to transmit electrical or mechanical power (forward or reverse) to meet a wide range of speed/torque duty cycles. Forward, the Multi-Speed Transmission (MST) may drive wheels in heavy vehicles (transport, mining, farming, battlefield platforms, etc.) or in reverse, it may drive a generator from low speed flow (wind and water) turbines to generate energy. Special configurations may also be used in manufacturing where the duty cycles varies widely (mixing a product while its viscosity changes over a wide range). The following issues may be better managed.

### 1. Efficiency

The goal is to keep the prime mover as close to its torque/speed efficiency sweet spot as possible.

### 2. Durability

Here, the objective is to minimize internal torque and speed values in order to reduce gear component wear, noise, temperature, lubricant viscosity loss, and the like.

### 3. Start-Up

Heavy machinery may require short term high output torques at start-up because of internal striction, high inertia, low speed high output loads, and the like.

### 4. Output Management

The output function in terms of speed, torque, acceleration, and the like may vary widely and may be best matched by choosing among 4 distinct speed ratios in the 4-speed transmission.

### 5. Weight Distribution

In complex machinery, it may be best to transmit power at higher speeds (lower torque) until the point of output action where a 4-speed transmission can then transform that power to the best combination of torque and speed. This then reduces upfront weight in the system.

### B. Four-Speed Transmission Used in Heavy Transport Drive Wheels

Increasingly, human command is necessary to best manage a wide spectrum of task parameters under computer-based control. The power supply itself may be highly nonlinear. The task duty cycle may be very complex. This is certainly true of vehicles which demand a wide range of power transfer speed ratios to maximize choices (efficiency, pollution, acceleration, gradability and the like) on an urban bus, fleet vehicle, a cross-country truck, locomotive, deep-surface mine truck, or the like. This includes the desire to regenerate energy going downhill or stopping (i.e., the reverse of power transmission). To regenerate energy efficiently requires a very low shifting latency going from high gear sequentially shifting to low gear with minimal energy loss (not achievable at a single speed high reduction ratio), climbing a hill (in a deep surface mine) demands high efficiency and high torque at low speeds while going downhill, energy recovery requires low torque at high speeds. A heavily loaded truck on a sharp curve requires high traction force on one side of the vehicle and low traction on the other side. Clearly, a 4-speed MST dramatically increases choices (about 200 for 4 wheels, and about 2000 for 8 wheels). As with all responses to command (decision making), task complexity requires as many transmission choices as possible to best meet a given human need.

### C. Recommended Layout of the 4-Speed MST

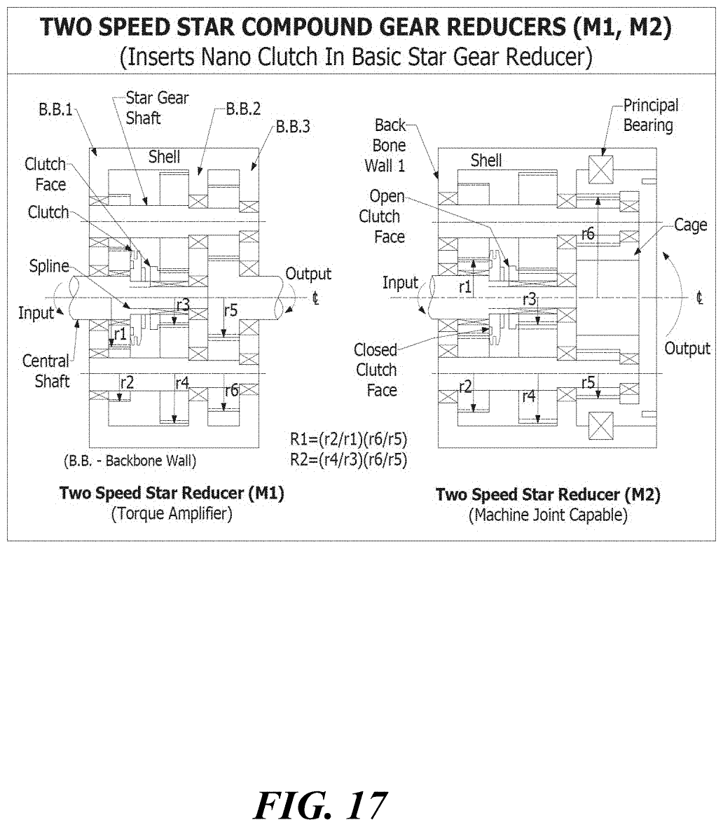

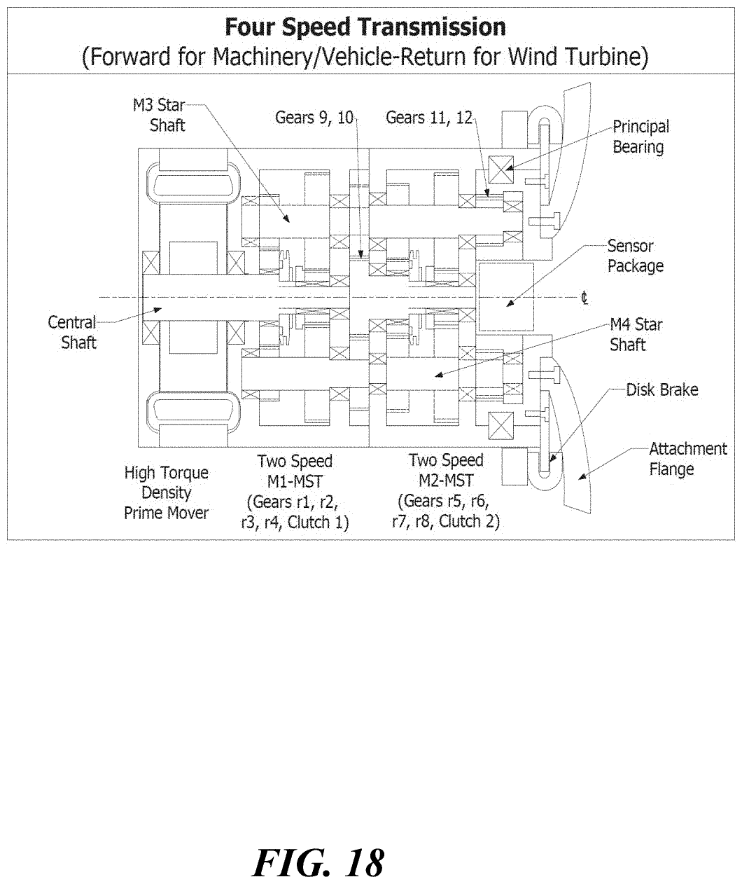

To achieve compactness (low weight, low complexity, low cost, high efficiency), the MST will preferably utilize the simplest of mechanical components (gears, bearings, clutches) in an unusually rugged assembly with modest internal gear ratios. FIG. 17 shows two integrated modules for that purpose. Module M1 uses a two-speed star compound gear train with ratios r₂/r₁ and r₄/r₃ with a coaxial dog clutch (shifted with a stepper motor) to drive an output reducer bull gear r₁₀/r₉. Module M2 is also a star compound gear train with ratios r₆/r₅ and r₈/r₇ (with a clutch) which then drives an internal gear with the ratio r₁₂/r₁₁ The last gear plane r₁₂/r₁₁ supports a wide diameter attachment plate supported by a principal bearing between the shell and the output plate in a very rugged shortest force path configuration (high stiffness in all directions). This principal bearing can now provide a joint constraint for the drive wheel, or a set of turbine blades, or a propeller on a large boat (lightly or heavily loaded). None of the gear ratios are large in the combined MI and M2 to ensure compactness, durability, efficiency whether running in forward or reverse to create a 4-speed MST (FIG. 18). The four speeds provide 3 shift ratios Δⱼᵢ that may be equal or increasing at the upper end, so that:

ΔS₁₂<ΔS₂₃<ΔS₃₄ (EQUATION 14)

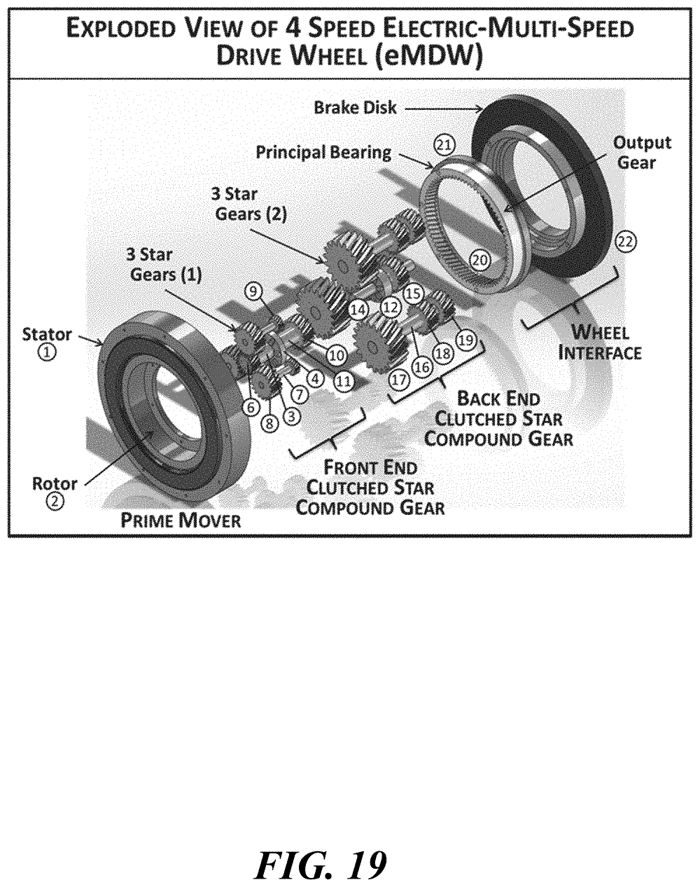

FIG. 19 shows an open exploded view of a possible configuration for the 4-speed MST. Given the layout in FIG. 2, where M1 drives M2, leaves the ratio choices:

$$\frac{{r}_{2}}{{r}_{1}} , \frac{{r}_{4}}{{r}_{3}} , \frac{{r}_{6}}{{r}_{5}} , \frac{{r}_{8}}{{r}_{7}} , \frac{{r}_{10}}{{r}_{9}} , \frac{{r}_{12}}{{r}_{11}}$$

If the choice is:

$$\frac{{r}_{2}}{{r}_{1}} = 0.6 , \frac{{r}_{4}}{{r}_{3}} = 2. , \frac{{r}_{6}}{{r}_{5}} = 1.2 , \frac{{r}_{8}}{{r}_{7}} = 2.5 , \frac{{r}_{10}}{{r}_{9}} = 2 , \frac{{r}_{12}}{{r}_{11}} = 2.5$$

then this results in the pass-through ratios:

R₁=3.6, R₂=7.50, R₃=14.4, R₄=30.0,

with shift ratios of:

ΔS₁₂=2.08, ΔS₂₃=1.91, ΔS₃₄=2.08.

This provides a total shift ratio of ΔS₁₄=8.33. These values would be very useful for heavy vehicles with complex duty cycles. The 36″ wheel velocity at 60 mph is 550 RPM in gear 2, requiring a motor speed of 4162 RPM; at 90 mph in gear 1, the motor speed would be 3070 RPM. At 30 mph in gear 3, the motor speed would be 3960 RPM. In the creeper gear 4, 3900 RPM would allow operation at 14 mph. Hence, the motor would be designed for a base speed of 4000 RPM. Generally, starting from rest, the sequence of gear ratios would start from low gear sets 4 and 3 to shift to the high gear sets 2 and 1.

This raises the question of choices of speed ratio selections on issues such as, for example, motor input speed, efficiency, mesh velocity speeds, gradeability, freewheeling gear speeds and acceleration, which then become the basis of the requirement for an extremely fast decision process. The questions that remain are cost (certified production in minimum sets from a responsive supply chain), and torque density (say, at 60 to 80 horsepower per wheel). Fortunately, weight is not a great maneuver issue for heavy vehicles, even though it directly affects payload.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

What is claimed is:

1. A rotary actuator, comprising:
a first clutched star compound gear;
a second clutched star compound gear;
an output attachment plate which rotates about a central axis;
an outer attachment shell; and
a principal bearing having a first surface which is attached to said output attachment plate, and a second surface which is attached to said outer attachment shell;
wherein said output attachment plate has a first major surface; and
wherein said output attachment plate, said outer attachment shell and said principal bearing are arranged such that a first line exists which is perpendicular to said first major surface of said output attachment plate and which passes through said output attachment plate, said principal bearing and said outer attachment shell, and wherein said first line is parallel to said central axis.

2. The rotary actuator of claim 1, wherein said first line passes through said output attachment plate, said principal bearing and said outer attachment shell, in that order.

3. The rotary actuator of claim 1, wherein said output plate is axially concentric about said central axis.

4. The rotary actuator of claim 1, wherein said outer attachment shell is axially concentric about said central axis.

5. The rotary actuator of claim 1, wherein said principal bearing has rotational concentricity about said central axis.

6. The rotary actuator of claim 1, wherein said output attachment plate, said outer attachment shell and said principal bearing are arranged such that a first cylinder exists which passes through said output attachment plate, said principal bearing and said outer attachment shell, and wherein said first cylinder has an axis which is perpendicular to said output attachment plate.

7. The rotary actuator of claim 6, wherein said first major surface is a second circle, and wherein said first and second circles are concentric.

8. The rotary actuator of claim 6, wherein said output plate rotates about a central axis, and wherein said output plate is axially concentric about said central axis.

9. The rotary actuator of claim 8, wherein said principal bearing has rotational concentricity about said central axis.

10. The rotary actuator of claim 1, wherein said output attachment plate contains a first annulus, wherein said outer attachment shell contains a second annulus, and wherein said principal bearing contains a third annulus, and wherein said output attachment plate, said outer attachment shell and said principal bearing are arranged such that said first, second and third annuli are concentric.

11. The rotary actuator of claim 10, wherein a cylinder exists whose surface intersects and is concentric with said first, second and third annuli.

12. The rotary actuator of claim 11, wherein said cylinder is a right cylinder.

13. The rotary actuator of claim 12, wherein said output plate rotates about a central axis, and wherein said output plate is axially concentric about said central axis.

14. The rotary actuator of claim 13, wherein said outer attachment shell is axially concentric about said central axis.

15. The rotary actuator of claim 14, wherein said principal bearing has rotational concentricity about said central axis.

16. The rotary actuator of claim 1, wherein said output attachment plate, said outer attachment shell and said principal bearing are arranged such that a force applied in a first direction normal to said output attachment plate is transmitted through said principal bearing and said outer attachment shell with essentially no transmission of force in a direction orthogonal to said first direction.

17. The rotary actuator of claim 1, wherein said outer attachment plate and said outer attachment shell are rigid in a direction orthogonal to a major surface of said outer attachment plate.

18. The rotary actuator of claim 1, wherein said outer attachment plate is supported on an annular back wall, and wherein said back wall is supported on said outer attachment shell.
